(19) United States
(12) Patent Application Publication
(10) Pub. No.: US 2017/0214609 A1
(43) Pub. Date: Jul. 27, 2017

(54) FORWARDING METHOD AND FORWARDING DEVICE

(71) Applicant: FUJITSU LIMITED, Kawasaki-shi (JP)

(72) Inventor: Hiroyuki Fujii, Kawasaki (JP)

(73) Assignee: FUJITSU LIMITED, Kawasaki-shi (JP)

(21) Appl. No.: 15/375,791

(22) Filed: Dec. 12, 2016

(30) Foreign Application Priority Data
Jan. 21, 2016 (JP) 2016-010135

(51) Int. Cl. H04L 12/713; H04L 12/46; H04L 12/715

(52) U.S. Cl. CPC H04L 45/586; H04L 45/64; H04L 12/4641

(57) ABSTRACT

A forwarding method executed by a processor included in a first forwarding device in a network in which redundancy is provided by using the first forwarding device and a second forwarding device that operate based on a processing rule of a packet set in a control device, the forwarding method includes acquiring, from the second forwarding device, a processing rule received by the second forwarding device from the control device and control information used to maintain a communication session between the second forwarding device and the control device; and starting communication with the control device through the communication session by using the control information when a given packet for alive monitoring has not been received from the second forwarding device for a given period or longer.

### CROSS-REFERENCE TO RELATED APPLICATION

This application is based upon and claims the benefit of priority of the prior Japanese Patent Application No. 2016-010135, filed on Jan. 21, 2016, the entire contents of which are incorporated herein by reference.

### FIELD

The present embodiment relates to a forwarding method and a forwarding device.

### BACKGROUND

In recent years, research and development on a system compatible with software defined networking (SDN) have been being advanced. Furthermore, various SDN controllers, SDN switches, SDN routers, and so forth have been provided. The OpenFlow protocol is often used for communications between the controller and the switch or router.

Meanwhile, as a protocol to support providing redundancy of the router on the Internet, there is a protocol such as the virtual router redundancy protocol (VRRP). In the VRRP, communications at the time of the occurrence of a failure in a router in operation is enabled by using a virtual internet protocol (IP) address.

FIG. 1 is a diagram for explaining an example of communications in a network using a VRRP. The network illustrated in FIG. 1 includes terminals 5 (5a and 5b), an L2 switch 15, and routers 10 (10a to 10c). The router 10a and the router 10b are included in a VRRP group.

Each router 10 included in the VRRP group holds information on priority and an address set as the destination of packets that are to reach the respective devices. In FIG. 1, the router 10a has information represented in a table T1 and the router 10b has information represented in a table T2. The priority of the router 10a is 200. The priority of the router 10b is 100. Here, the router 10 having the larger value of priority operates as an active router. Thus, in the example of FIG. 1, the router 10a operates as the active router and the router 10b operates as a backup router. For this reason, if communications through the router 10a as the active router are possible, packets to a virtual IP address used for communications in the VRRP group are processed in the router 10a. Therefore, in the table T1, as addresses of the processing target for the router 10a, the virtual address used in the VRRP group is also included besides real IP address=192.168.1.10 and real MAC address=AA-BB-CC-DD-EE-01. In the example of FIG. 1, virtual IP address=192.168.1.1 and virtual MAC address=00-00-5E-00-01-01 are used in the VRRP group. On the other hand, at timing represented in FIG. 1, the router 10b processes packets addressed to real IP address=192.168.1.11 and real MAC address=AA-BB-CC-DD-EE-02. Moreover, the router 10a that is operating as the active router periodically transmits a control packet toward the router 10b while the router 10a is normally operating (arrow A1). This allows the router 10b to detect a failure in the router 10a.

A table T3 is an example of information held by the terminal 5a. A table T4 is an example of information held by the terminal 5b. In the example of FIG. 1, the IP address assigned to the terminal 5a is 192.168.10.1 and the IP address assigned to the terminal 5b is 192.168.10.2. In both of the terminal 5a and the terminal 5b, the IP address of the default gateway is set to the virtual IP address used in the VRRP group (192.168.1.1).

In the state of FIG. 1, the terminal 5a acquires the virtual MAC address used in the VRRP group from the router 10a by carrying out an address resolution protocol (ARP) to the default gateway. Thus, when transmitting packets addressed to a device in another subnet, the terminal 5a sets the virtual MAC address (00-00-5E-00-01-01) as the destination MAC address. Therefore, packets that are transmitted from the terminal 5a and are addressed to the device in another subnet are forwarded from the router 10a toward the destination (arrow A2). Transmission of packets from the terminal 5b to a device in another subnet is also similarly carried out (arrow A3).

If a failure in the router 10a occurs, the router 10b processes packets in which the virtual address used in the VRRP group is set as the destination. For this reason, even when the terminal 5a or the terminal 5b transmits packets in which the virtual IP address of the default gateway or the virtual MAC address is set as the destination, the packets are processed by the router 10b similarly to before the occurrence of the failure in the router 10a.

As a related art, an OpenFlow network system to which network equipment made redundant may be coupled has been proposed (for example, Japanese Laid-open Patent Publication No. 2013-211706 and so forth). In this system, a switch forwards a VRRP packet received from a router and a gratuitous ARP (GARP) packet received from an active router in a VRRP group to a controller and the controller controls the switch in the system. A data relay device that includes a main router, a backup router, and a virtual router and in which route information is shared between the main router and the backup router has also been proposed (for example, Japanese Laid-open Patent Publication No. 2004-282176 and so forth). If a failure occurs in the main router, the backup router activates the virtual router to cause the virtual router to exchange route information with other routers, and updates the route information by using the route information acquired by the virtual router.

If pieces of equipment made redundant by using the VRRP or the like are coupled to a network in which processing of packets is decided by a controller, all pieces of equipment made redundant process packets in accordance with setting from the controller. Thus, the controller transmits control information to both of equipment in operation and equipment for backup. For this reason, the load on the controller is large and the processing efficiency is low. If the transmission of the control information to the equipment for backup is carried out from timing before switching of equipment occurs, the controller ensures communication paths both between the controller and the equipment in operation and between the controller and the equipment for backup and thus the use efficiency of the communication path is low. On the other hand, if the control information is transmitted from the controller to the equipment for backup after the switching, it takes a long time until processing of packets is started after the switching and therefore the processing efficiency is low. Similar problems occur in all techniques cited as the related arts. In the above description, an example of the case in which the VRRP is used as an example of providing redundancy is depicted. However, similar problems occur also when a method for providing redundancy other than the VRRP is used. In view of the above, it is desirable that the efficiency of communications in a network in which redundancy is provided may be improved.

### SUMMARY

According to an aspect of the embodiment, a forwarding method executed by a processor included in a first forwarding device in a network in which redundancy is provided by using the first forwarding device and a second forwarding device that operate based on a processing rule of a packet set in a control device, the forwarding method includes acquiring, from the second forwarding device, a processing rule received by the second forwarding device from the control device and control information used to maintain a communication session between the second forwarding device and the control device; and starting communication with the control device through the communication session by using the control information when a given packet for alive monitoring has not been received from the second forwarding device for a given period or longer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an example of communications in a network using a VRRP;

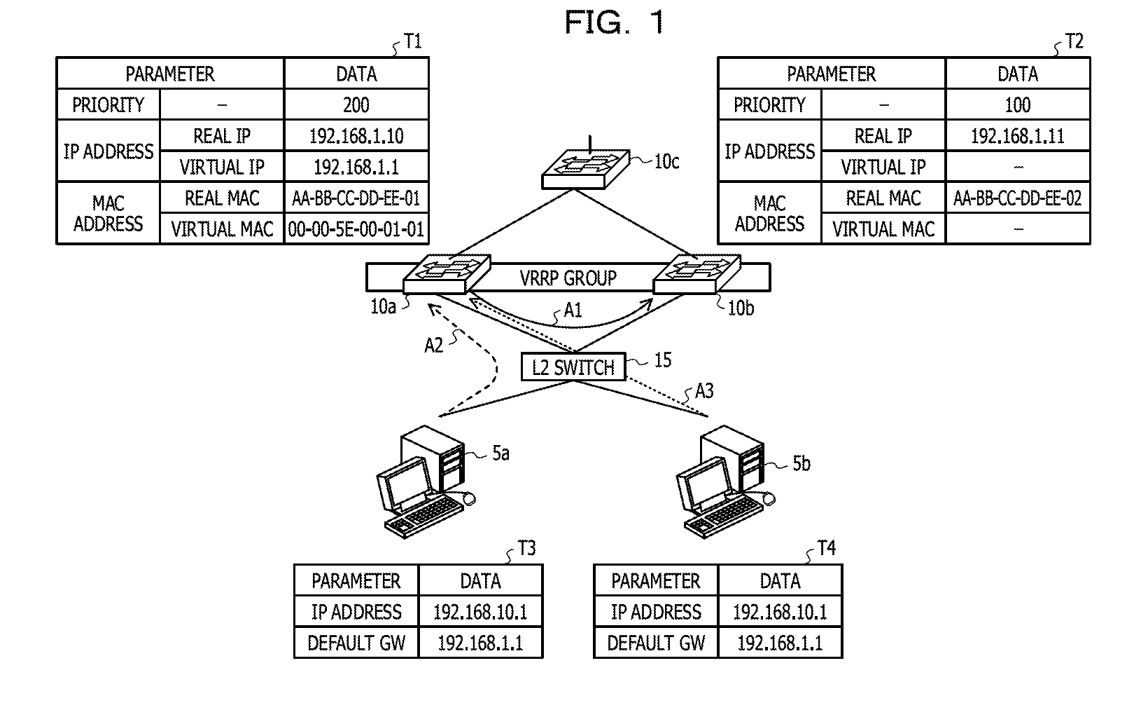

FIG. 2 is a diagram for explaining an example of a communication method according to an embodiment;

FIG. 3 is a diagram for explaining an example of a configuration of a forwarding device;

FIG. 4 is a diagram for explaining an example of a hardware configuration of a forwarding device;

FIG. 5 is a sequence diagram for explaining an example of processing executed in establishment of a session between a control device and a forwarding device;

FIG. 6 is a diagram for explaining examples of information elements in messages transmitted and received between a control device and a forwarding device;

FIG. 7 is a diagram for explaining an example of control information notified to a backup-side forwarding device;

FIG. 8 is a flowchart for explaining an example of processing executed in a master-side forwarding device;

FIG. 9 is a diagram for explaining examples of information elements in messages transmitted and received between a control device and a forwarding device;

FIG. 10 is a diagram for explaining an example of a flow table;

FIG. 11 is a diagram for explaining an example of a group table;

FIG. 12 is a flowchart for explaining an example of processing executed in a master-side forwarding device;

FIG. 13 is a flowchart for explaining an example of processing executed in a backup-side forwarding device;

FIG. 14 is a diagram for explaining an example of alive monitoring between a control device and a forwarding device;

FIG. 15 is a diagram for explaining an example of communication processing with a control device when a master-side forwarding device has detected a failure in a line;

FIG. 16 is a sequence diagram for explaining an example of switching processing when a master-side forwarding device has detected a failure in a line;

FIG. 17 is a diagram for explaining an example of a VRRP information table;

FIG. 18 is a diagram for explaining an example of port information;

FIG. 19 is a flowchart for explaining an example of processing executed in a master-side forwarding device;

FIG. 20 is a flowchart for explaining an example of processing executed in a backup-side forwarding device;

FIG. 21 is a sequence diagram for explaining an example of switching processing when a failure has occurred in a master-side forwarding device;

FIG. 22 is a diagram for explaining an example of communication processing with a control device when a failure has occurred in a master-side forwarding device;

FIG. 23 is a diagram for explaining an example of transmission processing of port information;

FIG. 24 is a diagram for explaining an example of a system to which a forwarding method according to an embodiment is applied;

FIG. 25 is a diagram for explaining an example of pieces of information held by respective devices;

FIG. 26 is a diagram for explaining an example of a case in which a failure in a line is detected in a master-side forwarding device;

FIG. 27 is a diagram for explaining an example of information held by a switch;

FIG. 28 is a diagram for explaining an example of a port information table;

FIG. 29 is a diagram for explaining an example of a state when switching processing has been completed;

FIG. 30 is a diagram for explaining an example of a case in which a failure occurs in a master-side forwarding device; and

FIG. 31 is a diagram for explaining an example of a state when switching processing has been completed.

### DESCRIPTION OF EMBODIMENT

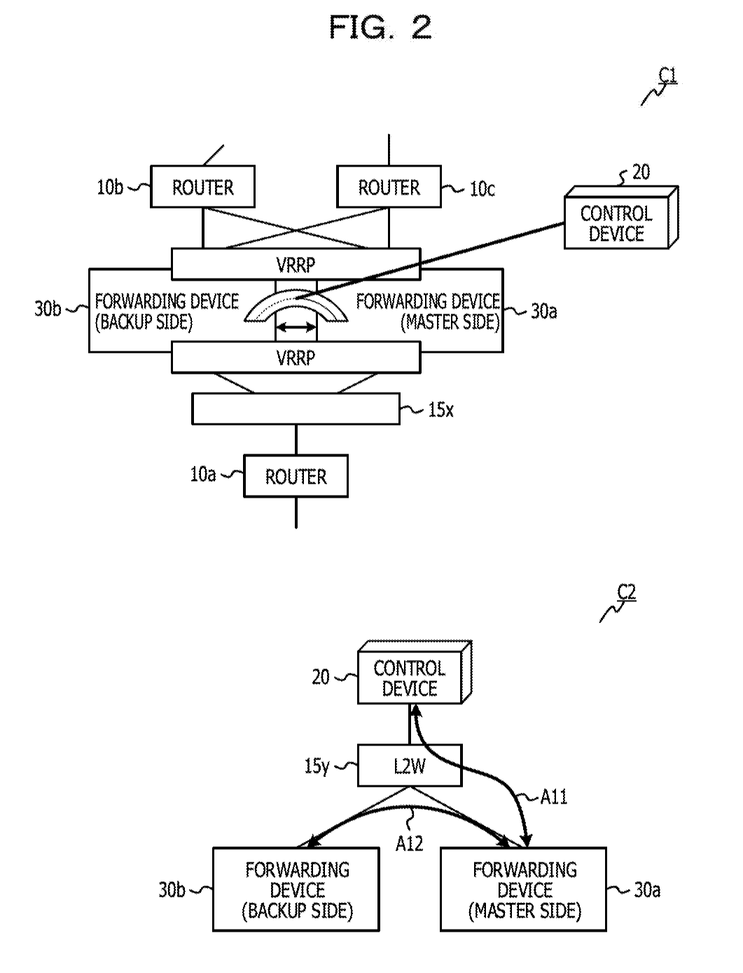

FIG. 2 is a diagram for explaining an example of a communication method according to an embodiment. A system illustrated in a case C1 of FIG. 2 includes routers 10 (10a to 10c) that are not made redundant, L2 switches 15, a control device 20, and forwarding devices 30 (30a and 30b). The forwarding device 30a and the forwarding device 30b are included in one redundant group. For example, the forwarding device 30a and the forwarding device 30b are coupled to the router 10a with the intermediary of the L2 switch 15x. Packets are forwarded to a device in operation by the L2 switch 15x.

In the following description, the forwarding device 30a is in operation and the forwarding device 30b is operating as a device for backup when a failure has occurred in the forwarding device 30a. In the following description and the drawings, the forwarding device 30 in operation will be often described as the “master-side” forwarding device 30 for facilitation of understanding. On the other hand, the forwarding device 30 serving as a backup for the master-side forwarding device 30 will be often described as the “backup-side” forwarding device 30. In the example of FIG. 2, the case in which the forwarding device 30a and the forwarding device 30b are made redundant by the VRRP will be described as one example. However, the forwarding device 30a and the forwarding device 30b may be made redundant by an arbitrary method. Part of the L2 switches 15 will be often omitted because of the space on the plane of paper. However, the devices in the VRRP group are each coupled to devices that are not included in the VRRP group in which the self-device is included with the intermediary of the L2 switch 15 as appropriate.

The control device 20 controls forwarding processing in the network by deciding processing in each device regarding packets transmitted and received by the routers 10 and the forwarding devices 30 in the network and notifying each device of the contents of the decided processing. If the OpenFlow protocol is used in the network, the control device 20 is implemented as an OpenFlow controller and the routers 10 and the forwarding devices 30 are implemented as OpenFlow switches.

Here, the control device 20 establishes a communication session with one of the forwarding device 30a and the forwarding device 30b. However, the control device 20 does not establish a communication session with the other forwarding device 30. In FIG. 2, the state in which only one of the forwarding device 30a and the forwarding device 30b establishes a coupling with the control device 20 is represented by coupling a straight line extending from the control device 20 to a thick circular arc linking the forwarding device 30a and the forwarding device 30b. In the forwarding device 30a and the forwarding device 30b linked by the thick circular arc, the master-side forwarding device 30a establishes a communication session with the control device 20 as represented by a solid line in the circular arc. A dashed line in the circular arc indicates that the backup-side forwarding device 30b does not establish a communication session with the control device 20. Meanwhile, a communication session is established between the forwarding device 30a and the forwarding device 30b in order to synchronize control information. Moreover, the forwarding device 30a communicates with each of the routers 10a to 10c as appropriate with use of a virtual address used in the VRRP group.

A case C2 of FIG. 2 represents an example of communication sessions and communication routes by which control information is transmitted and received. Switching of the coupling described by using the circular arc in the case C1 is carried out by the L2 switch 15y. If the forwarding device 30a does not store the processing method of packets received from the routers 10a to 10c, the forwarding device 30a transmits a request packet to request the contents of processing of the received packets to the control device 20 through a session represented by an arrow A11. Hereinafter, the processing method of packets notified from the control device 20 will be often described as the “processing rule.” The control device 20 decides processing for packets in the forwarding device 30a, about which the inquiry using the request message is made, by using information on the destination of the packet, topology information of the network, and so forth, and notifies the forwarding device 30a of the decided processing. The forwarding device 30a processes packets in accordance with the processing rule and stores the processing rule.

Moreover, the forwarding device 30a notifies the processing rule to the forwarding device 30b through a communication session represented by an arrow A12. The forwarding device 30b stores the processing rule notified from the forwarding device 30a. Furthermore, the forwarding device 30b also acquires, from the forwarding device 30a, information on the session used by the forwarding device 30a for communications with the control device 20, information transmitted and received through the session, and so forth through the communication session represented by the arrow A12.

The forwarding device 30a periodically transmits a control packet for notifying that the forwarding device 30a is normally operating to the forwarding device 30b through the session of the arrow A12. On the other hand, if a failure occurs in the forwarding device 30a or if an abnormality occurs in the line between the forwarding device 30a and the router 10a to 10c, the forwarding device 30a stops the transmission of the control packet. Thus, if the forwarding device 30b does not receive the packet from the forwarding device 30a for a period equal to or longer than a given period, the forwarding device 30b determines that a failure has occurred in the forwarding device 30a. Then, the forwarding device 30b takes over the session with the control device 20 by using the control information received from the forwarding device 30a. For example, the forwarding device 30b starts communications with the control device 20 by using the virtual IP address assigned to the VRRP group, the control information, and so forth before the timeout of the communication session between the forwarding device 30a and the control device 20.

Furthermore, the forwarding device 30b also starts processing of data packets with use of the virtual address used in the VRRP group. At this time, the forwarding device 30b processes packets received from the routers 10a to 10c by using the processing rule notified from the forwarding device 30a in advance. Moreover, when receiving packets to which the already-stored processing rule is not applied, the forwarding device 30b acquires a new processing rule by communicating with the control device 20 by use of the communication session taken over from the forwarding device 30a.

As above, in the communication method according to the embodiment, it suffices that the control device 20 only communicates with one forwarding device 30 in the VRRP group. For this reason, in the method according to the embodiment, the amount of communications between the control device 20 and the forwarding device 30 may be reduced compared with the case in which the control device 20 communicates with all forwarding devices 30 in the VRRP group. The forwarding device 30b receives information such as the processing rule from the master-side forwarding device 30a instead of the control device 20. Thus, hot standby of the backup-side forwarding device 30b may be implemented with reduction in the amount of communications between the control device 20 and the forwarding device 30. This may suppress also transmission of a large amount of control information from the control device 20 when the backup-side forwarding device 30b starts operation as the master side as in the case in which the forwarding device 30b is in cold standby. In the method according to the embodiment, compared with the case in which the control device 20 concurrently communicates with all forwarding devices 30 in the VRRP group, the number of routes used at a time for communications between the control device 20 and the forwarding device 30 is small and thus the network is also made efficient. Therefore, the efficiency of communications in the network in which redundancy is provided may be improved by the method according to the embodiment.

Also in the following description, explanation will be made by taking as an example the case in which redundancy is implemented by the VRRP. However, the method used for providing redundancy may be an arbitrary method other than the VRRP.

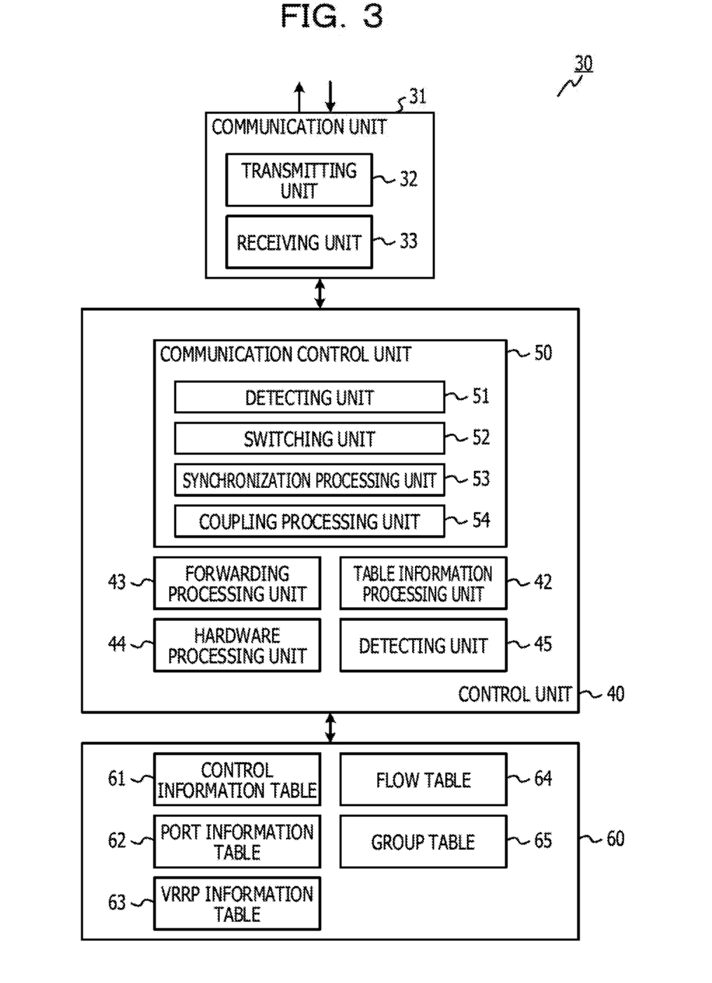

FIG. 3 is a diagram for explaining an example of a configuration of a forwarding device. The forwarding device illustrated in FIG. 3 may be the forwarding device 30 illustrated in FIG. 2. The forwarding device 30 includes a communication unit 31, a control unit 40, and a storing unit 60. The forwarding device 30 includes a transmitting unit 32 and a receiving unit 33. The control unit 40 includes a communication control unit 50, a table information processing unit 42, a forwarding processing unit 43, a hardware processing unit 44, and a detecting unit 45. The communication control unit 50 includes a detecting unit 51, a switching unit 52, a synchronization processing unit 53, and a coupling processing unit 54. The storing unit 60 holds a control information table 61, a port information table 62, a VRRP information table 63, a flow table 64, and a group table 65.

The transmitting unit 32 transmits packets to other devices such as the control device 20 and the routers 10. The receiving unit 33 receives packets from other devices such as the control device 20 and the routers 10. The forwarding processing unit 43 operates when the forwarding device 30 is operating as the master-side forwarding device 30. The forwarding processing unit 43 forwards packets received from the router 10 in accordance with the processing rule. The forwarding processing unit 43 also generates a request packet for requesting the control device 20 to transmit the processing rule. In the master-side forwarding device 30, the table information processing unit 42 records control information received from the control device 20 in the control information table 61, and records the processing rule in the flow table 64, and records setting information of each group in the group table 65. The table information processing unit 42 of the backup-side forwarding device 30 records information received from the master-side forwarding device 30 in the control information table 61, the flow table 64, and the group table 65. In the port information table 62, information on the status of each port the forwarding device 30 has and so forth is recorded. In the VRRP information table 63, management information such as virtual addresses used in providing redundancy by the VRRP is recorded. Examples of the control information table 61, the port information table 62, the VRRP information table 63, the flow table 64, and the group table 65 will be described later. The hardware processing unit 44 executes setting processing of a switch circuit 104 and so forth as appropriate. In the master-side forwarding device 30, the detecting unit 45 detects a communication failure between the master-side forwarding device 30 and the router 10 or the control device 20 in the network.

The communication control unit 50 executes switching processing, synchronization processing of control information, and so forth. The detecting unit 51 and the switching unit 52 operate in the backup-side forwarding device 30 and the synchronization processing unit 53 and the coupling processing unit 54 operate in the master-side forwarding device 30. The coupling processing unit 54 establishes a communication session between the control device 20 and the master-side forwarding device 30. The synchronization processing unit 53 generates a packet for notifying the backup-side forwarding device 30 of a processing rule acquired from the control device 20, control information used for maintaining a communication session with the control device 20, and so forth. Moreover, if a failure has not occurred in routes through the master-side forwarding device 30, the synchronization processing unit 53 periodically transmits a control packet to notify that a failure has not occurred to the backup-side forwarding device 30 through the transmitting unit 32. The detecting unit 51 detects the occurrence of a failure in the master-side forwarding device 30 by using the reception interval of the control packet from the master-side forwarding device 30. Also when the master-side forwarding device 30 detects a failure in a line, the transmission of the control packet is stopped. Thus, if the backup side does not receive the control packet, the backup side may determine that a failure has occurred in the master-side forwarding device 30 or a forwarding route through the master-side forwarding device 30. The switching unit 52 executes processing for causing the backup-side forwarding device 30 to take over a communication session between the control device 20 and the master-side forwarding device 30. Moreover, the switching unit 52 executes setting processing for receiving packets addressed to the virtual address in order to carry out communications with the routers 10a to 10c.

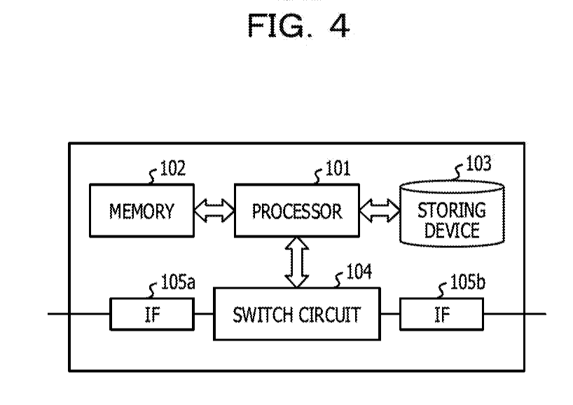

FIG. 4 is a diagram for explaining an example of a hardware configuration of a forwarding device. The forwarding device illustrated by reference to FIG. 4 may be the forwarding device 30 illustrated in FIG. 2. The forwarding device 30 includes a processor 101, a memory 102, a storing device 103, the switch circuit 104, and interfaces 105 (105a and 105b). The processor 101 is a processor such as a central processing unit (CPU). The memory 102 includes a random access memory (RAM) and a read only memory (ROM) and functions as a buffer. Besides, the memory 102 records information used for processing in the processor 101, information obtained by processing in the processor 101, and so forth. The memory 102 or the storing device 103 stores a program executed by the processor 101. The switch circuit 104 is used for switching at the time of forwarding processing of packets. The interfaces 105 couple to the network and execute processing for communications with another device.

In the forwarding device 30, the processor 101 implements the control unit 40. The communication unit 31 is implemented by the interfaces 105. Moreover, the memory 102 and the storing device 103 operate as the storing unit 60.

In the following, description will be so made that the subject is categorized into taking over control information used for communications between the control device 20 and the forwarding device 30, synchronization processing of a processing rule, alive monitoring between the control device 20 and the forwarding device 30, and switching processing between the master-side forwarding device 30 and the backup-side forwarding device 30. Moreover, in the following description, in order to facilitate understanding of which device of the master-side and backup-side devices relates to processing, the constituent element in the device will be often so described that the same alphabet as the end of the reference numeral of the forwarding device 30 is given to the end of the reference numeral of the constituent element. For example, the synchronization processing unit 53a represents the synchronization processing unit 53 in the forwarding device 30a.

(1) Taking Over Control Information Used for Communications between Control Device 20 and Forwarding Device 30

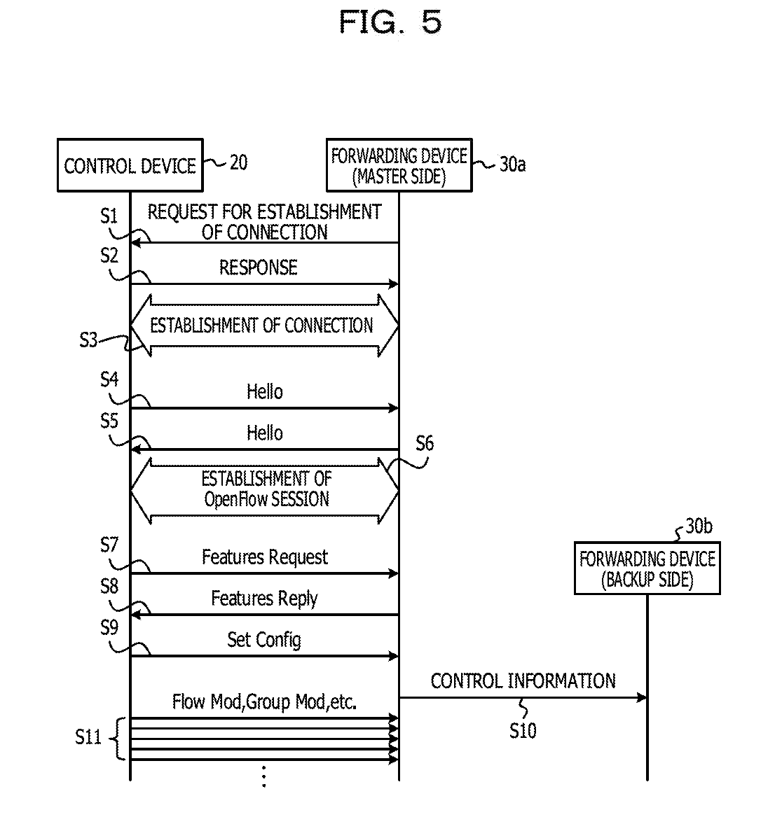

FIG. 5 is a sequence diagram for explaining an example of processing executed in establishment of a session between a control device and a forwarding device. The control device and the forwarding device illustrated in FIG. 5 may be the control device 20 and the forwarding device 30a illustrated in FIG. 2. In the following description, explanation will be made by taking as an example the case in which the OpenFlow protocol and the transmission control protocol (TCP) are used. However, the kinds of protocols that are used may be changed according to the implementation. The coupling processing unit 54a in the forwarding device 30a transmits a request for establishment of a TCP connection to the control device 20 (S1). When a response to notify permitting establishment of a connection is transmitted from the control device 20 to the forwarding device 30a, a connection is established between the control device 20 and the forwarding device 30a (S2 and S3).

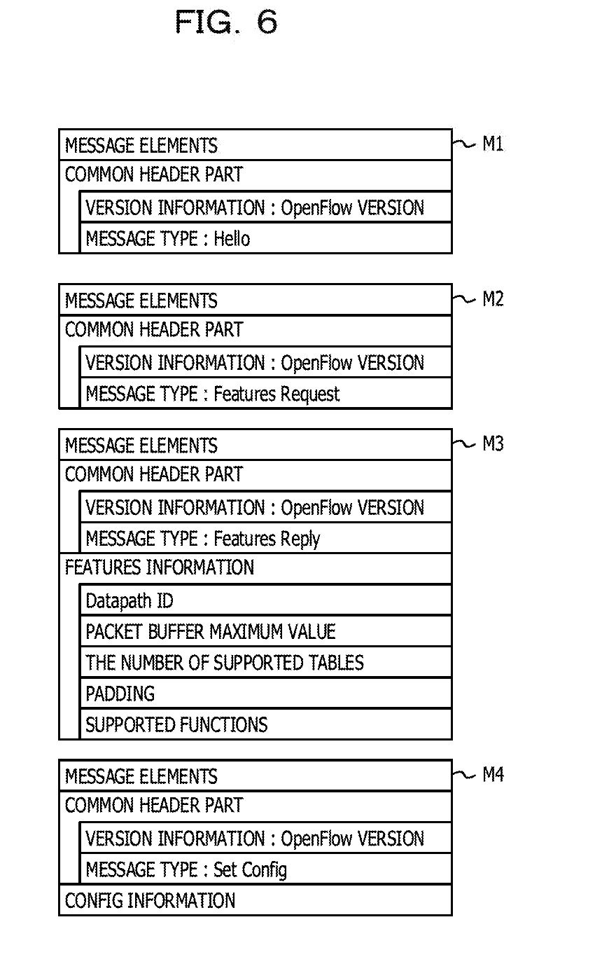

The receiving unit 33a receives a Hello message from the control device 20 (S4). Examples of information elements included in messages transmitted and received in FIG. 5, such as the Hello message, will be described later with reference to FIG. 6. The coupling processing unit 54a transmits a Hello message to the control device 20 and thereby establishes an OpenFlow session between the control device 20 and the forwarding device 30a (S5 and S6).

After the OpenFlow session is established, the control device 20 transmits a Features Request message toward the forwarding device 30a (S7). The receiving unit 33a receives the Features Request message and outputs the Features Request message to the coupling processing unit 54a. In response to the Features Request message, the coupling processing unit 54a transmits a Features Reply message including information on the maximum value of the packet buffer of the forwarding device 30a and so forth to the control device 20 (S8). Thereupon, the control device 20 transmits a Set Config message to the forwarding device 30a (S9).

The coupling processing unit 54a acquires the Set Config message through the receiving unit 33a. Meanwhile, the synchronization processing unit 53a selects control information to be notified to the backup-side forwarding device 30b from information notified to the control device 20 by the Features Reply message or information obtained by the Set Config message. The synchronization processing unit 53a transmits the control information selected as the notification object to the forwarding device 30b through the transmitting unit 32a (S10). The table information processing unit 42b of the forwarding device 30b records the control information acquired from the forwarding device 30a in the storing unit 60b.

Meanwhile, the control device 20 transmits a processing rule that has been set by the control device 20 and so forth to the master-side forwarding device 30a. Thus, the forwarding device 30a receives a FlowMod message and a GroupMod message from the control device 20 (S11). The table information processing unit 42a records information notified by the FlowMod message in the flow table 64a. The table information processing unit 42a records information notified by the GroupMod message in the group table 65a.

Although not clearly represented in the sequence diagram of FIG. 5, the synchronization processing unit 53a of the master-side forwarding device 30a periodically transmits a control packet for notifying that the forwarding device 30a is normally operating to the forwarding device 30b.

FIG. 6 is a diagram for explaining examples of information elements included in messages transmitted and received between a control device and a forwarding device. The control device and the forwarding device illustrated by reference to FIG. 6 may be the control device 20 and the forwarding device 30 illustrated in FIG. 2. The examples of FIG. 6 are one example. For example, in all messages, an information element other than the information elements represented in FIG. 6 may be included in the common header part.

M1 in FIG. 6 is an example of the information elements in the Hello message. The Hello message is transmitted and received in S4 and S5 in FIG. 5. The Hello message includes a common header part and may further include an optional information element. However, the optional information element does not have to be included in the Hello message as represented in M1. The common header part includes the OpenFlow version of the device as the transmission source and the message type (Hello).

M2 is the information elements in the Features Request message. The Features Request message is transmitted in S7 in FIG. 5. In the Features Request message, the OpenFlow version used by the control device 20 as the transmission source and the message type (Features Request) are included.

M3 is the information elements in the Features Reply message. The Features Reply message is transmitted from the forwarding device 30a in S8 in FIG. 5 in order to notify the control device 20 of information representing the performance of the forwarding device 30a. The Features Reply message includes a common header part and Features information. In the example of M3, the Features information includes a Datapath ID, the packet buffer maximum value, the number of tables supported by the forwarding device 30a as the transmission source, and information on functions supported by the forwarding device 30a as the transmission source, and includes padding as appropriate. The contents of the Features information may be changed according to the implementation. The common header part includes the OpenFlow version used by the forwarding device 30a as the transmission source and the message type (Features Reply).

M4 is an example of the information elements in the Set Config message. The Set Config message is transmitted from the control device 20 to the forwarding device 30a in S9 in FIG. 5. The Set Config message includes a common header part and Config information. In the Config information, for example, a Config flag, the maximum number of bytes of information transmitted from the control device 20, and so forth are included.

By using the information notified by these messages, the master-side forwarding device 30a executes communication processing with the control device 20. Moreover, the synchronization processing unit 53a in the forwarding device 30a selects information used to maintain the communication session with the control device 20 as the control information to be notified to the backup-side forwarding device 30b from the information acquired from the control device 20 by using the respective messages in FIG. 6.

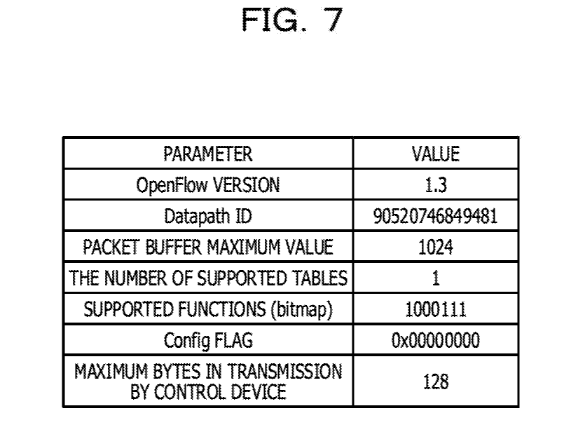

FIG. 7 is a diagram for explaining an example of control information notified to a backup-side forwarding device. The backup-side forwarding device illustrated by reference to FIG. 7 may be the backup-side forwarding device 30 illustrated in FIG. 2. In the example of FIG. 7, the OpenFlow version, the Datapath ID, the packet buffer maximum value, the number of supported tables, the information on supported functions, the Config flag, and the maximum number of bytes of information transmitted from the control device 20 are included in the control information. In FIG. 7, the OpenFlow version is the version of the OpenFlow protocol used by the control device 20. In the example of FIG. 7, the control device 20 uses version 1.3 of the Open Flow. The Datapath ID is identification information used in uniquely identifying the OpenFlow session between the forwarding device 30a and the control device 20. The Datapath ID is a value of 90520746849481 in the example of FIG. 7. The packet buffer maximum value is the value of the buffer notified to the control device 20 as the value of packets that may be buffered by the forwarding device 30a. The packet buffer maximum value is set equal to or smaller than the upper limit value of the buffer that may be used both by the forwarding device 30a and by the forwarding device 30b. The number of supported tables is a value notified to the control device 20 by the forwarding device 30a as the number of tables supported by the forwarding device 30a. The number of supported tables is a value set equal to or smaller than the upper limit value of the number of tables that may be used both by the forwarding device 30a and by the forwarding device 30b. The information on supported functions is a value notified to the control device 20 by the forwarding device 30a as information on functions supported by the forwarding device 30a. The information on supported functions is a value selected from functions that may be provided both by the forwarding device 30a and by the forwarding device 30b. FIG. 7 is one example of the control information. The kinds of information elements and the values of the respective pieces of information selected as the information to be notified from the master-side forwarding device 30 are arbitrarily changed according to the implementation.

After selecting the control information to be notified to the backup-side forwarding device 30b as illustrated in FIG. 7, the synchronization processing unit 53a transmits a packet including the control information to the backup-side forwarding device 30b as described for S10 in FIG. 5. The receiving unit 33b of the forwarding device 30b outputs the information received from the master-side forwarding device 30a to the table information processing unit 42b. Thereupon, the table information processing unit 42b records the input control information in the storing unit 60b.

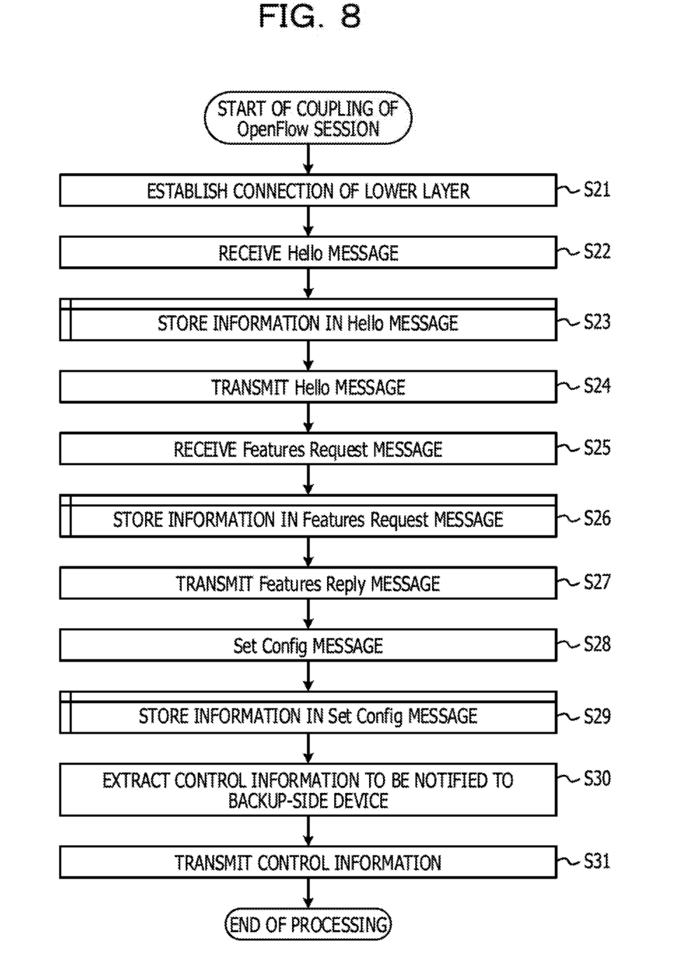

FIG. 8 is a diagram for explaining an example of processing executed in a master-side forwarding device. The master-side forwarding device illustrated by reference to FIG. 8 may be the master-side forwarding device 30 illustrated in FIG. 2. The coupling processing unit 54 in the forwarding device 30 executes connection establishment processing at a lower layer than the OpenFlow, such as the TCP, with the control device 20 (S21). The receiving unit 33 receives a Hello message transmitted from the control device 20 (S22). The table information processing unit 42 stores information in the Hello message in the storing unit 60 (S23). The coupling processing unit 54 transmits a Hello message to the control device 20 (S24). The receiving unit 33 receives a Features Request message transmitted from the control device 20 (S25). If parameter information is included in the Features Request message, the table information processing unit 42 stores the parameter information in the storing unit 60 (S26). The coupling processing unit 54 transmits a Features Reply message to the control device 20 (S27). The receiving unit 33 receives a Set Config message transmitted from the control device 20 (S28). The table information processing unit 42 stores information in the Set Config message in the storing unit 60 (S29). The synchronization processing unit 53 selects control information as an object to be transmitted to the backup-side forwarding device 30 from the information in the storing unit 60, and transmits the control information to the backup-side forwarding device 30b through the transmitting unit 32 (S30 and S31).

(2) Synchronization Processing of Processing Rule

Next, synchronization processing when a processing rule is notified from the control device 20 to the forwarding device 30 will be described. The processing rule is notified from the control device 20 to the master-side forwarding device 30a by using a FlowMod message and a GroupMod message.

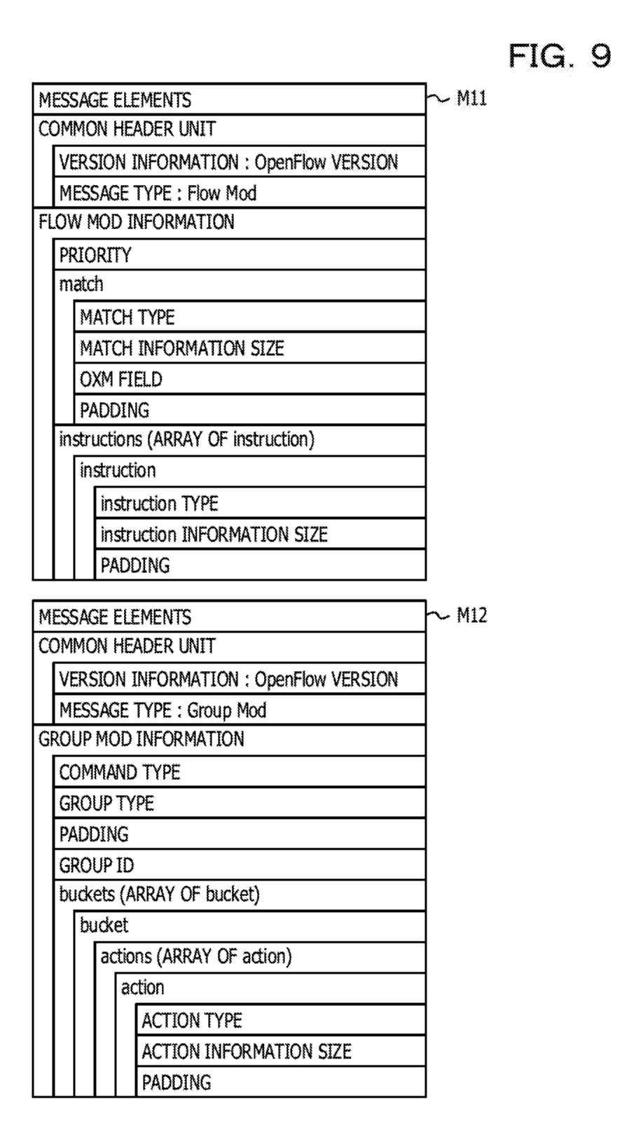

FIG. 9 is a diagram for explaining examples of information elements in messages transmitted and received between a control device and a forwarding device. The control device and the forwarding device illustrated by reference to FIG. 9 may be the control device 20 and the forwarding device 30 illustrated in FIG. 2. M11 represents an example of the information elements included in the FlowMod message. The FlowMod message is transmitted from the control device 20 to the forwarding device 30a in S11 in FIG. 5. The FlowMod message includes a common header part and FlowMod information. In the example of M11, the FlowMod information includes priority, match conditions, and instructions. Each match condition is associated with instruction. In the example of FIG. 9, as the match conditions, the match type, match information size, an OpenFlow extensible match (OXM) field, and padding are included. Meanwhile, as instruction, the instruction type, instruction information size, and padding are included.

M12 represents an example of the information elements included in the GroupMod message. The GroupMod message is also transmitted from the control device 20 to the forwarding device 30a in S11 in FIG. 5. The GroupMod message includes a common header part and GroupMod information. In the example of M12, the GroupMod information includes the command type, the group type, padding, a group ID, and bucket information. The group type is information on the kind of group to which the information in the GroupMod message is applied. The group type is used for determination of whether to carry out all pieces of bucket information, and so forth. The group ID is the identifier of the group to which the information in the GroupMod message is applied. The bucket information includes information on a monitoring port and so forth and action information. The action information includes the action type, action information size, and padding. The action type indicates the contents of processing executed in the relevant group.

The information elements included in the FlowMod message and the GroupMod message may be changed according to the implementation. The table information processing unit 42a updates the flow table 64 and the group table 65 by using these pieces of information received from the control device 20.

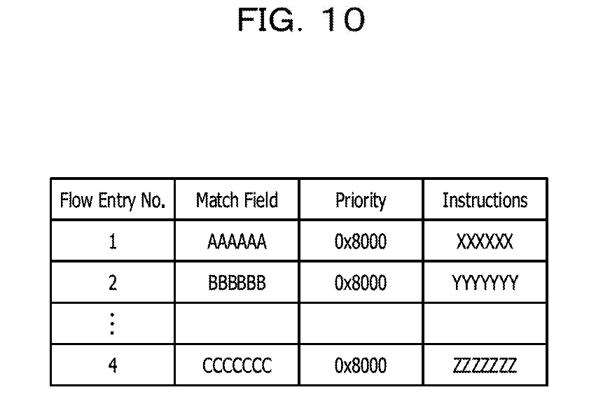

FIG. 10 is a diagram for explaining an example of a flow table. The flow table illustrated in FIG. 10 may be the flow table 64 illustrated in FIG. 3. In the flow table 64 illustrated in FIG. 10, a flow entry number, a match field, priority, and instruction information are included. The forwarding processing unit 43a in the forwarding device 30a determines consistency with the conditions in the match field (match conditions) in order of the priority regarding a packet received from the router 10. When detecting the match condition corresponding to the received packet, the forwarding processing unit 43a executes processing of instruction corresponding to the match condition.

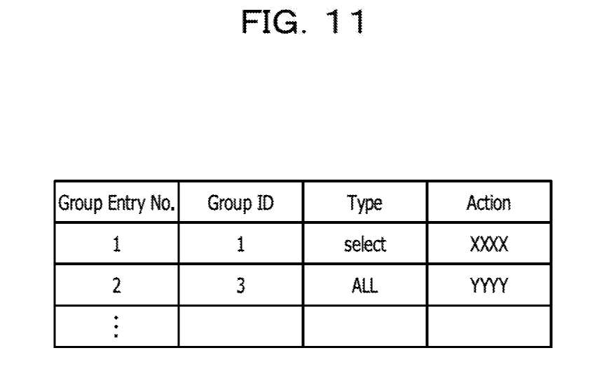

FIG. 11 is a diagram for explaining an example of a group table. The group table illustrated in FIG. 11 may be the group table 65 illustrated in FIG. 3. The group table of FIG. 11 includes a group entry number, a group ID, the type, and action information. The type is information notified by the GroupMod message as the group type. The forwarding processing unit 43a in the forwarding device 30a carries out load distribution and so forth in processing of packets received from the router 10 by using the group of the port identified by the group ID and so forth.

When the flow table 64a and the group table 65a are updated in the master-side forwarding device 30a, the synchronization processing unit 53a obtains the difference between the flow table 64a after the update and the flow table 64a before the update as table update information of the flow table 64. Similarly, the synchronization processing unit 53a obtains the difference between the group table 65a after the update and the group table 65a before the update as table update information of the group table 65. The synchronization processing unit 53a transmits the obtained pieces of table update information to the backup-side forwarding device 30b, with each of the pieces of table update information associated with the kind of table.

The receiving unit 33b of the forwarding device 30b receives a packet including the pieces of table update information and outputs the received packet to the table information processing unit 42b. The table information processing unit 42b updates the flow table 64b and the group table 65b by using the pieces of table update information in the input packet. For this reason, the backup-side forwarding device 30b may acquire the processing rule set in the control device 20 by using the information from the master-side forwarding device 30a although not communicating with the control device 20.

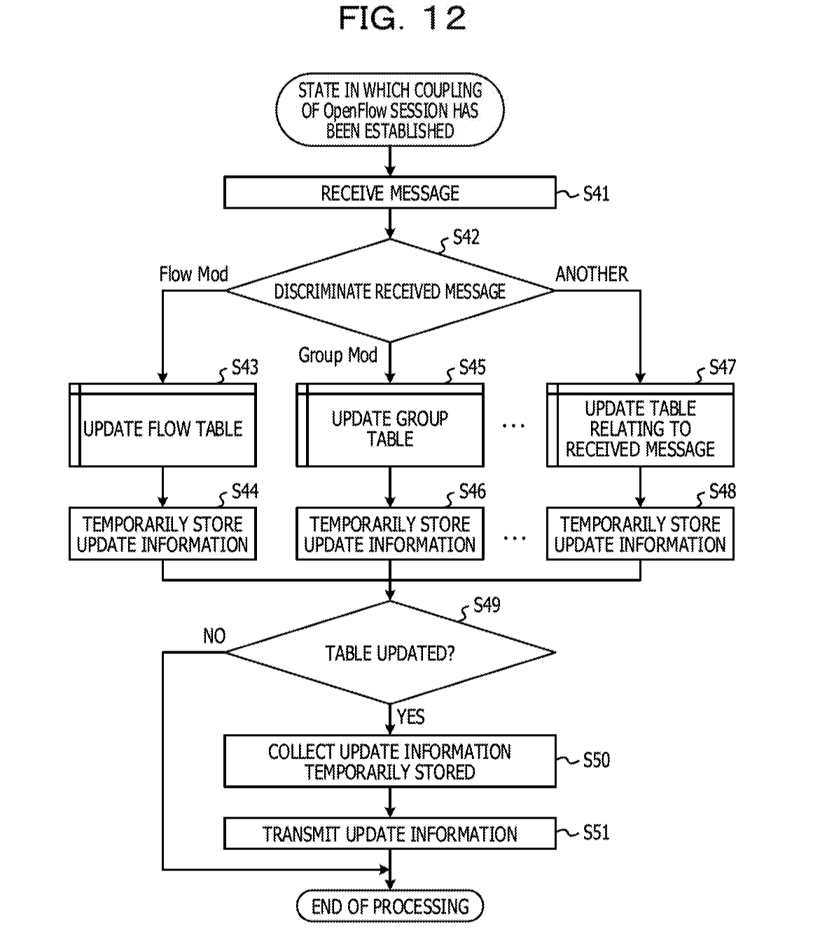

FIG. 12 is a flowchart for explaining an example of processing executed in a master-side forwarding device. The master-side forwarding device illustrated by reference to FIG. 12 may be the master-side forwarding device 30 illustrated in FIG. 2. The receiving unit 33 receives a message from the control device 20 (S41). The table information processing unit 42 discriminates the kind of message (S42). If the message is a FlowMod message, the table information processing unit 42 updates the flow table 64 and temporarily stores update information of the flow table 64 (S43 and S44). If the message is a GroupMod message, the table information processing unit 42 updates the group table 65 and temporarily stores update information of the group table 65 (S45 and S46). Similarly, also regarding another message, the table information processing unit 42 updates the table relating to the message and temporarily stores update information (S47 and S48).

The synchronization processing unit 53 determines whether any table stored in the storing unit 60 is updated (S49). If any table stored in the storing unit 60 is updated, the synchronization processing unit 53 collects pieces of information temporarily stored as pieces of update information of the respective tables (Yes in S49, and S50). The synchronization processing unit 53 transmits the collected pieces of update information to the backup-side forwarding device 30 through the transmitting unit 32 (S51). At this time, the synchronization processing unit 53 may employ, as the transmission object, information in which each of the collected pieces of update information is associated with the kind of message used for acquisition of each of the update information. The synchronization processing unit 53 may employ, as the transmission object, information in which each of the collected pieces of update information is associated with the kind of table updated by each of the update information. On the other hand, if none of the tables stored in the storing unit 60 is updated, the synchronization processing unit 53 ends the processing (No in S49).

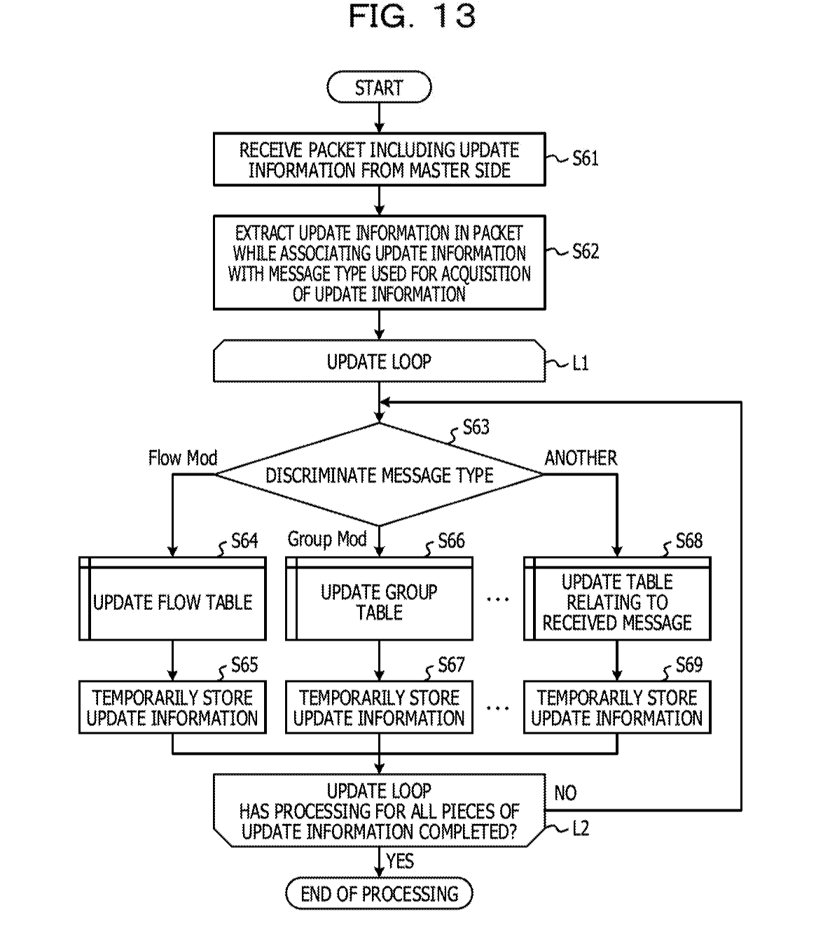

FIG. 13 is a flowchart for explaining an example of processing executed in a backup-side forwarding device. The backup-side forwarding device illustrated by reference to FIG. 13 may be the backup-side forwarding device 30 illustrated in FIG. 2. In the example of FIG. 13, update information is transmitted from the master-side forwarding device 30, with the update information associated with the type of message used for acquisition of each of the update information.

The receiving unit 33 receives a packet including the update information from the master-side forwarding device 30 (S61). The table information processing unit 42 analyzes the received packet. Then, the table information processing unit 42 extracts the update information included in the received packet while associating the update information with the type of message used for acquisition of the update information (S62). Next, loop processing between loop ends L1 and L2 is executed. Hereinafter, the loop between the loop ends L1 and L2 will be often described as the “update loop.” The table information processing unit 42 selects table update information of the processing target and discriminates the type of message used for acquisition of the selected update information (S63). Processing executed in S64 to S69 is similar to processing of S43 to S48 described with reference to FIG. 12. After the processing of any of S65, S67, and S69, the table information processing unit 42 determines that processing for all pieces of update information included in the received packet has ended (loop end L2). If processing for all pieces of update information included in the received packet has not ended, the processing of S63 and the subsequent processing are repeated (No at loop end L2). On the other hand, if processing for all pieces of update information included in the received packet has ended, the table information processing unit 42 ends the processing (Yes at loop end L2).

(3) Alive Monitoring between Control Device 20 and Master-Side Forwarding Device 30

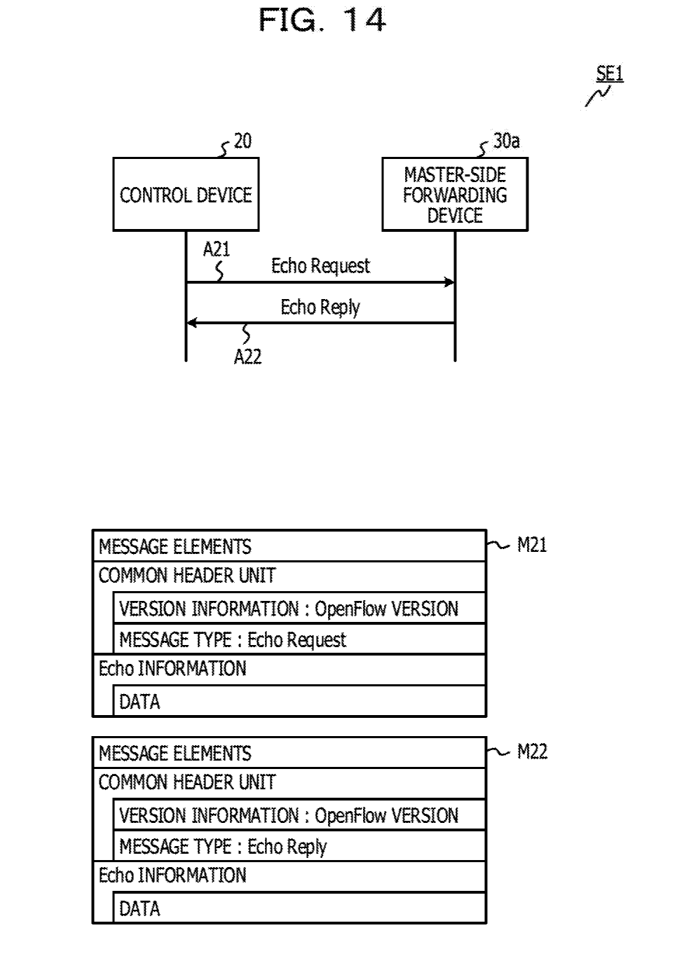

FIG. 14 is a diagram for explaining an example of alive monitoring carried out between a control device and a master-side forwarding device. The control device and the master-side forwarding device illustrated in FIG. 14 may be the control device 20 and the master-side forwarding device 30 illustrated in FIG. 2. A sequence SE1 is an example of the alive monitoring in the case in which the forwarding device 30a is operating as the master side. In the example of the sequence SE1, the control device 20 transmits an Echo Request message to the master-side forwarding device 30a (arrow A21).

M21 of FIG. 14 is an example of information elements included in the Echo Request message. The Echo Request message includes a common header part and Echo information. The common header part includes the OpenFlow version used by the control device 20 as the transmission source and the message type (Echo Request). The Echo information includes data transmitted by Echo Request. However, in the alive monitoring, data does not have to be included in the Echo information.

The receiving unit 33a of the forwarding device 30a receives the Echo Request message. The detecting unit 45a generates an Echo Reply message that responds to the Echo Request message. Then, the detecting unit 45a transmits the Echo Reply message to the control device 20 through the transmitting unit 32a (arrow A22 in the sequence SE1).

M22 of FIG. 14 is an example of information elements included in the Echo Reply message. The Echo Reply message includes a common header part and Echo information. The common header part includes the OpenFlow version used by the forwarding device 30a as the transmission source and the message type (Echo Reply). The Echo information includes data transmitted by Echo Reply. However, as with the Echo Request message, in the alive monitoring, data does not have to be included in the Echo information.

In the sequence SE1, only one pair of messages are represented as the messages transmitted and received between the control device 20 and the forwarding device 30a. However, alive monitoring by the Echo messages is periodically carried out. The interval of transmission and reception of the Echo message is arbitrarily decided according to the implementation. However, the interval of transmission and reception is longer than the time it takes to execute switching processing of the forwarding device 30. The method of alive monitoring described by using FIG. 14 is one example and, for example, the messages used in the alive monitoring may be other kinds of control message.

(4) Switching Processing between Master-Side Forwarding Device and Backup-Side Forwarding Device

In the following, examples of processing will be described separately for the case in which switching processing of the forwarding device 30 is executed due to a failure in a line coupled to the master-side forwarding device 30a and for the case in which switching processing of the forwarding device 30 is executed due to the occurrence of a failure in the master-side forwarding device 30a.

[Case 1] Example of Processing when Failure has Occurred in Line

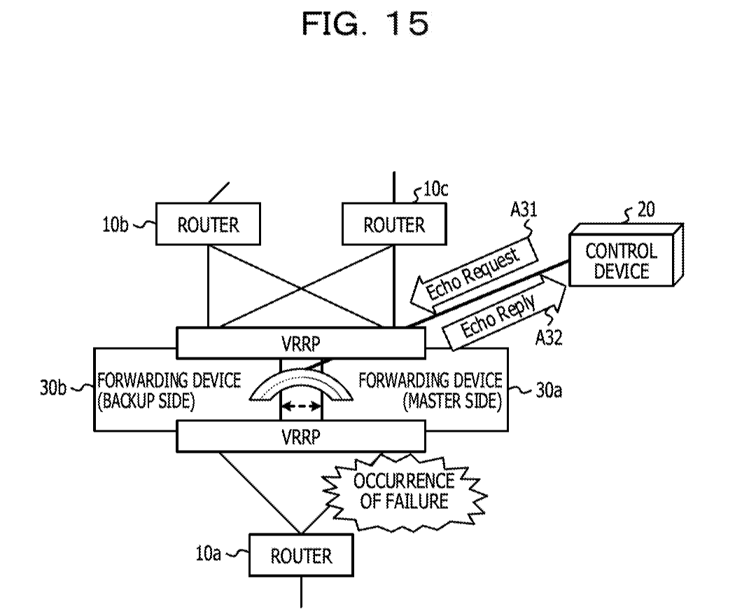

FIG. 15 is a diagram for explaining an example of communication processing with a control device when a master-side forwarding device has detected a failure in a line. The control device and the master-side forwarding device illustrated in FIG. 15 may be the control device 20 and the master-side forwarding device 30a illustrated in FIG. 2. The detecting unit 45a of the forwarding device 30a periodically carries out a communication check with each of the routers 10a to 10c and thereby detects the occurrence of a failure in the line between the forwarding device 30a and the coupled router 10. In the example of FIG. 15, the detecting unit 45a detects that a failure has occurred in the line between the router 10a and the forwarding device 30a. Also in FIG. 15, each of the forwarding device 30a and the forwarding device 30b is coupled to the router 10a with the intermediary of the L2 switch 15. However, the L2 switch 15 is not represented in FIG. 15 for easy viewing of the diagram. In the following description, the failure in the line has occurred between the L2 switch 15 and the forwarding device 30a. However, a failure has not occurred between the L2 switch 15 and the router 10a.

When the failure in the line is detected, the synchronization processing unit 53a stops transmission of the control packet and transmission of update information for synchronization to the forwarding device 30b in order to cause the forwarding device 30b to operate as the master side. In FIG. 15, the state in which the transmission of the control packet and the update information between the forwarding device 30a and the forwarding device 30b is represented by a dashed arrow that links the forwarding device 30a and the forwarding device 30b.

Also in the case in which the master-side forwarding device 30a has detected the failure in the line, the master-side forwarding device 30a responses to the message for alive monitoring carried out with the control device 20 in order to keep the communication session with the control device 20. For example, after the detecting unit 45a has detected the failure in the line, the forwarding device 30a receives an Echo Request message from the control device 20 as represented by an arrow A31. In this case, by the processing like the processing described with reference to FIG. 14, the detecting unit 45a generates an Echo Reply message and transmits the Echo Reply message to the control device 20 through the transmitting unit 32a (arrow A32).

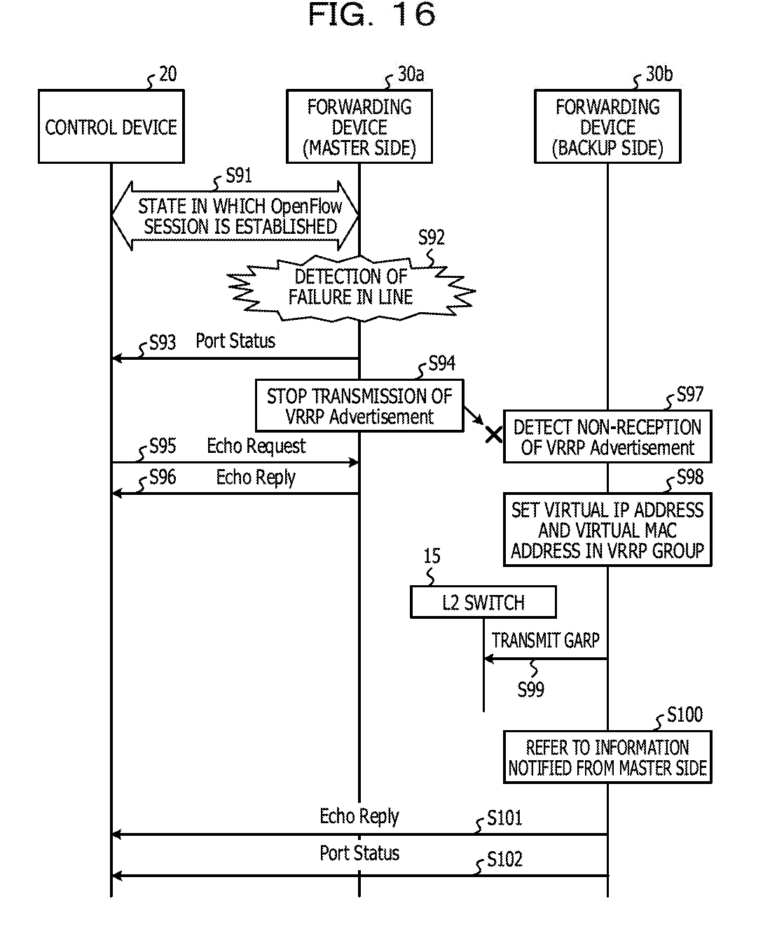

FIG. 16 is a sequence diagram for explaining an example of switching processing when a master-side forwarding device has detected occurrence of a failure in a line. The master-side forwarding device illustrated in FIG. 16 may be the master-side forwarding device 30a illustrated in FIG. 2. When the forwarding device 30a detects the occurrence of a failure in a line, the switching processing of the forwarding device 30 is executed in the state in which the communication session formed between the forwarding device 30a and the control device 20 is kept. Details of the switching processing will be described below with reference to FIG. 16. In the following description, the case in which VRRP Advertisement is used as a control packet to notify the forwarding device 30b of that a failure has not occurred in communications in the forwarding device 30a is taken as an example. However, the control packet may be changed according to the implementation. FIG. 16 is one example of the processing. Change in the order of the processing, such as execution of S94 before S93, may be made according to the implementation. The timing of a coupling such as a connection of a lower layer between the control device 20 and the backup-side forwarding device 30b is arbitrary timing before taking over the OpenFlow session.

At the timing of S91, a failure has not occurred in the line between the forwarding device 30a and the router 10a. In S91, the forwarding device 30a is operating as the master-side forwarding device 30 and thus has established the OpenFlow session with the control device 20. The synchronization processing unit 53a periodically transmits VRRP Advertisement to the forwarding device 30b. Thus, the detecting unit 51b of the forwarding device 30b determines that a failure has not occurred in the forwarding device 30a and communications through the forwarding device 30a are being carried out.

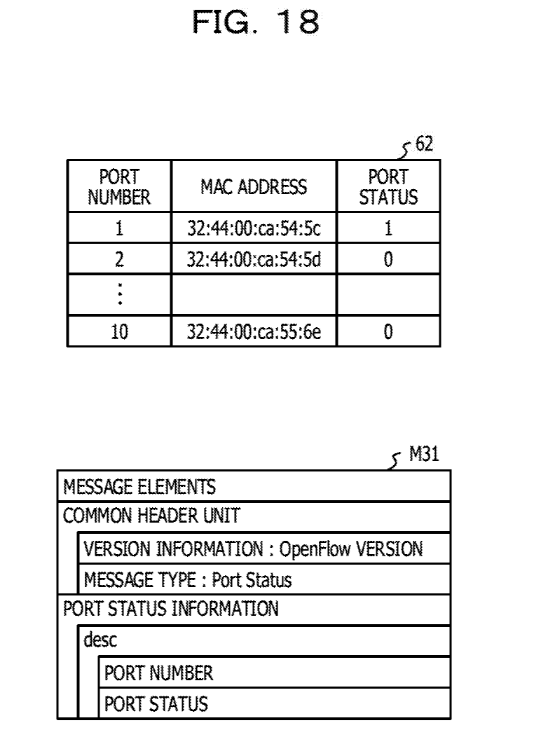

Thereafter, a failure occurs in the line between the router 10a and the forwarding device 30a. The detecting unit 45a detects the occurrence of the failure in the line between the forwarding device 30a and the router 10a (S92). The detecting unit 45a records, in the port information table 62a, that a failure has occurred in communications through the port coupled to the line in which the failure has occurred. For example, if the port coupled to the router 10a is port Pot, the detecting unit 45a writes that a failure has occurred in communications from port Pot to the port information table 62a. The detecting unit 45a generates a Port Status message including information in the port information table 62a and transmits the Port Status message to the control device 20 through the transmitting unit 32a (S93). Examples of the port information table 62 and the Port Status message will be described later with reference to FIG. 18. Furthermore, the synchronization processing unit 53a stops transmission of VRRP Advertisement (S94).

Meanwhile, the forwarding device 30a receives an Echo Request message from the control device 20 (S95). Thereupon, by the processing like the processing described with reference to FIG. 14 and FIG. 15, the detecting unit 45a generates an Echo Reply message and transmits the Echo Reply message to the control device 20 through the transmitting unit 32a (S96).

In association with the stop of transmission of VRRP Advertisement in S94, the forwarding device 30b is stopped from receiving VRRP Advertisement. If the forwarding device 30b has not received VRRP Advertisement for a given period or longer, the detecting unit 51b determines that a failure in communications through the master-side forwarding device 30a has occurred (S97). The switching unit 52b sets the virtual IP address and the virtual media access control (MAC) address assigned to the VRRP group as addresses for processing in the forwarding device 30b in order for the forwarding device 30b to operate as the master-side forwarding device 30 (S98). Moreover, the switching unit 52b transmits the GARP to the L2 switch 15 in the route from the router 10a to 10c to the forwarding device 30b (S99). An ARP table held by the L2 switch 15 is updated due to the transmission of the GARP. Thus, packets in which the virtual IP address or the virtual MAC address used in the VRRP group is specified as the destination are forwarded to the forwarding device 30b.

Thereafter, the switching unit 52b in the forwarding device 30b refers to the control information table 61b and acquires control information notified from the master-side forwarding device 30a (S100). By using the control information, the switching unit 52b transmits an Echo Reply message to the control device 20 through the communication session established between the control device 20 and the forwarding device 30a (S101). Here, the transmission of the Echo Reply message is carried out in case the response to the Echo Request message from the control device 20 is not sent from the forwarding device 30a. For example, in the case in which a failure occurs in the forwarding device 30a itself that operates as the master-side, the communication session established between the control device 20 and the forwarding device 30a is not discoupled. For this reason, the backup-side forwarding device 30 transmits the Echo Reply message to the control device 20 when the switching processing ends.

Here, description will be made about the time it takes to carry out the switching and the timing of alive monitoring. The period from the time at which the detecting unit 51b determines that a failure has occurred in communications through the master-side forwarding device 30a to transmission of an Echo Reply message is defined as a first period. Meanwhile, the period for which the control device 20 waits for Echo Reply in alive monitoring between the control device 20 and the forwarding device 30a is defined as a second period. In this case, the first period is set shorter than the second period.

As illustrated in FIG. 16, in the case in which a failure has not occurred in the forwarding device 30a, an Echo Reply message is transmitted from the forwarding device 30b although an Echo Reply message is transmitted from the forwarding device 30a. In this case, the Echo Reply message transmitted from the forwarding device 30b is discarded in the control device 20 and therefore a malfunction does not occur particularly.

Moreover, the switching unit 52b notifies the control device 20 of the status of ports in the forwarding device 30b by transmitting a Port Status message to the control device 20 (S102). For example, it is determined in the control device 20 that a failure has occurred in communications through port Pot because the control device 20 is notified of the status of a port of the forwarding device 30a in association with the failure in the line in S93. However, because communications through port Pot of the forwarding device 30b do not involve a failure, communications with the router 10a are enabled by switching of the master-side forwarding device 30 from the forwarding device 30a to the forwarding device 30b. Thereupon, in S102, the control device 20 is notified of that communications through port Pot are possible from the forwarding device 30b. In the control device 20, the communication status in the VRRP group is updated according to the status of the port in the forwarding device 30b. In the forwarding device 30a and the forwarding device 30b included in the VRRP group, the port number and the coupled object of the port identified by the port number are set to be the same.

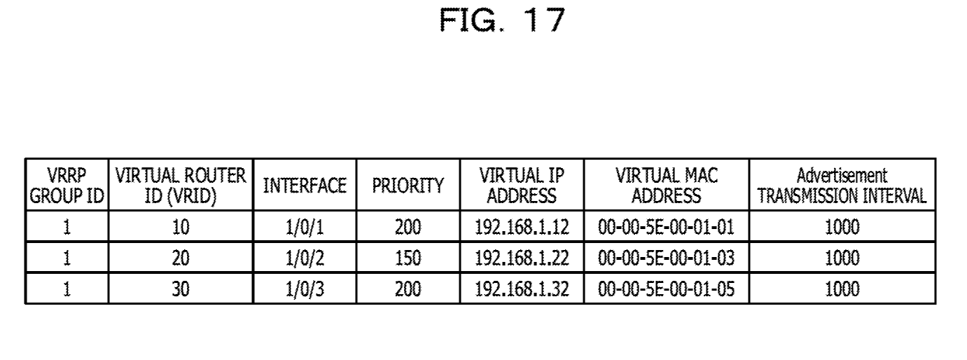

FIG. 17 is a diagram for explaining an example of a VRRP information table. The VRRP information table illustrated in FIG. 17 may be the VRRP information table 63 illustrated in FIG. 3. The VRRP information table 63 includes a VRRP group ID, a virtual router ID, an interface, priority, a virtual IP address, a virtual MAC address, and an Advertisement transmission interval. The VRRP group ID is identification information to identify the VRRP group. The virtual router ID is identification information of a virtual router used with a respective one of the interfaces. For example, interface 1/0/1 corresponds to coupling with the router 10a, the identifier (VRID) of the virtual router used by the forwarding device 30a and the forwarding device 30b for communications with the router 10a is 10. Similarly, if interface 1/0/2 corresponds to coupling with the router 10b, the VRID used by the forwarding devices 30a and 30b for communications with the router 10b is 20. If interface 1/0/3 corresponds to coupling with the router 10c, the VRID used by the forwarding devices 30a and 30b for communications with the router 10c is 30. The priority is the priority of the master-side forwarding device 30 in the interface. The virtual IP address and the virtual MAC address are a combination of the virtual IP address and the virtual MAC address set for the virtual router used for communications with a respective one of the interfaces. The Advertisement transmission interval is the time interval at which the master-side forwarding device 30a transmits VRRP Advertisement.

In S97 in FIG. 16, the detecting unit 51b acquires the transmission interval of Advertisement regarding each interface from the VRRP information table 63b. The detecting unit 51b compares the reception interval of VRRP Advertisement from the forwarding device 30a and the product of the transmission interval of Advertisement set regarding any interface and a value set in advance. If the reception interval of VRRP Advertisement becomes longer than the product of the transmission interval of Advertisement and the value set in advance, the detecting unit 51b determines that a failure has occurred in communications through the master-side forwarding device 30a. For example, when the value set in advance is 3, the detecting unit 51b detects a failure in communications through the forwarding device 30a if VRRP Advertisement has not been received for the period equivalent to three times the transmission interval of Advertisement regarding interface 1/0/1.

The detecting unit 51b may detect a failure in communications through the forwarding device 30a if the period for which VRRP Advertisement has not been received surpasses the Master Down Interval time (Tdown) calculated from expression (1).

Tdown=Int×3+(256−Pr)/256 (1)

Here, Int is the transmission interval of VRRP Advertisement and Pr is the priority of the master-side forwarding device 30a.

FIG. 18 is a diagram for explaining an example of port information. FIG. 18 represents an example of the port information table 62 and an example of the Port Status message. In the port information table 62, information on each port the forwarding device 30 has is recorded. In the example of FIG. 18, each entry includes a port number, a MAC address, and a port status. The MAC address is a MAC address assigned to the interface of the port identified by the port number. The port status is a value representing whether a failure has been detected in communications through the port. In the example of FIG. 18, regarding a port with port status=0, a failure has not been detected in communications through the port. On the other hand, regarding a port with port status=1, a failure has been detected in communications through the port. Therefore, in the port information table 62 illustrated in FIG. 18, that a failure has occurred in communications through the port with port number=1 is recorded.

M31 is an example of information elements included in the Port Status message. The Port Status message includes a common header part and Port Status information. The common header part includes the OpenFlow version used by the forwarding device 30 as the transmission source and the message type (Port Status). In the Port Status information, the number of a port included in the forwarding device 30 as the transmission source and the status of communications through the port identified by the port number are recorded in association with each other.

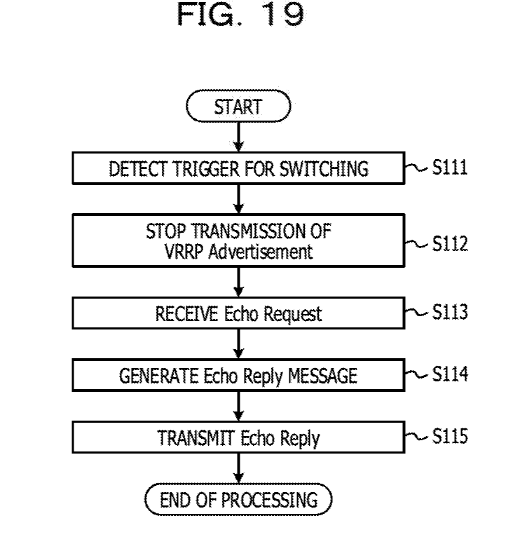

FIG. 19 is a flowchart for explaining an example of processing executed in a master-side forwarding device. The master-side forwarding device illustrated by reference to FIG. 19 may be the master-side forwarding device 30 illustrated in FIG. 2. The detecting unit 45 detects a phenomenon serving as a trigger for switching (S111). In the description made with reference to FIG. 15 and so forth, the trigger for switching is the occurrence of a failure in the line between the forwarding device 30 and the router 10 coupled to the forwarding device 30. The synchronization processing unit 53 stops transmission of VRRP Advertisement (S112). Thereafter, the receiving unit 33 receives an Echo Request message from the control device 20 (S113). Thereupon, the detecting unit 45 generates an Echo Reply message in order to keep the communication session with the control device 20 from being discoupled before switching processing with the backup side ends (S114). The detecting unit 45 transmits the Echo Reply message through the transmitting unit 32 (S115).

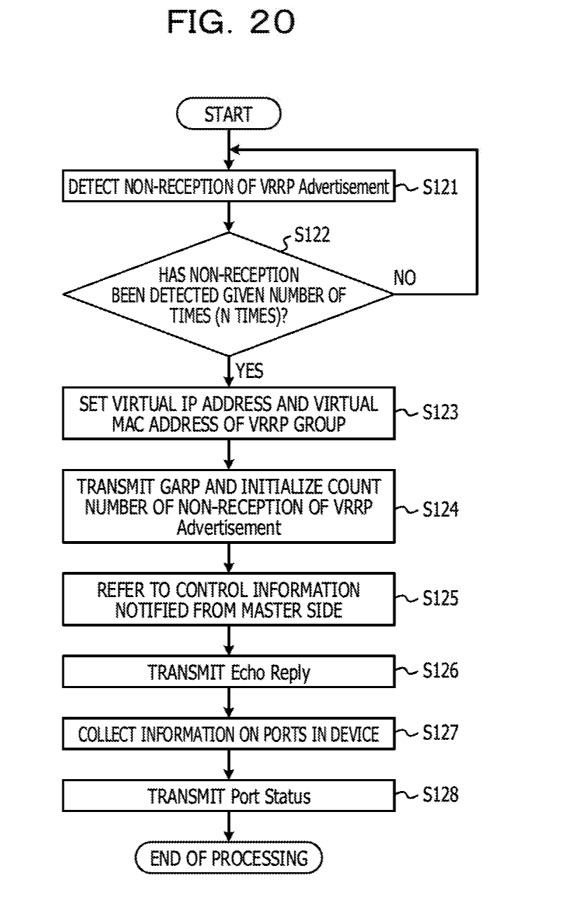

FIG. 20 is a flowchart for explaining an example of processing executed in a backup-side forwarding device. The backup-side forwarding device illustrated by reference to FIG. 20 may be the backup-side forwarding device 30 illustrated in FIG. 2. The detecting unit 51 reads the transmission interval of VRRP Advertisement from the VRRP information table 63 in advance. Thus, if transmission of VRRP Advertisement is stopped due to a failure in communications through the master-side forwarding device 30, the detecting unit 51 detects that VRRP Advertisement has not been received at the estimated time. The detecting unit 51 counts the number of times of the non-reception of VRRP Advertisement. The detecting unit 51 determines whether the non-reception of the present time is the given-number-th (N-th) non-reception of VRRP Advertisement (S122). If the number of times of non-reception of VRRP Advertisement is smaller than N times, the processing returns to S121 (No in S122). If the number of times of non-reception of VRRP Advertisement is N, the switching unit 52 executes setting processing for processing in the self-device regarding the virtual IP address and the virtual MAC address of the VRRP group (S123). Thereafter, the switching unit 52 transmits the GARP to the L2 switch 15. Then, the switching unit 52 initializes the count value of the number of times of non-reception of VRRP Advertisement.

The processing of S123 and S124 is executed about each of the virtual routers included in the VRRP group. For this reason, the processing of S123 and S124 is executed about each entry recorded in the VRRP information table 63. Therefore, in the example described with reference to FIG. 15 and so forth, the processing of S123 and S124 is executed about the interfaces between the forwarding device 30 and each of the routers 10a to 10c.

Next, the switching unit 52 refers to control information notified from the master-side forwarding device 30 (S125). The control information notified from the master-side forwarding device 30 is recorded as the control information table 61. By using the control information, the switching unit 52 transmits Echo Reply to the control device 20 through the communication session between the master-side forwarding device 30 and the control device 20 (S126). Moreover, the switching unit 52 collects information on the ports managed by the self-device by referring to the port information table 62 (S127). The switching unit 52 transmits a Port Status message including the collected information to the control device 20 (S128).

As above, also when the forwarding device 30 is switched, the backup-side forwarding device 30b uses the communication session established by the master-side forwarding device 30a with the control device 20. Thus, the control device 20 does not recognize the switching of the forwarding device 30. For this reason, the control device 20 does not retransmit the processing rule that has been already transmitted to the forwarding device 30a to the forwarding device 30b after the switching processing. Therefore, useless communications between the control device 20 and the forwarding device 30 are reduced. The forwarding device 30b has already acquired the processing rule received by the master-side forwarding device 30a from the control device 20 when the forwarding device 30b is the backup side. For this reason, the forwarding processing unit 43b of the forwarding device 30b may execute processing of packets in accordance with the processing rule although the processing rule that has been already transmitted to the forwarding device 30a by the control device 20 is not newly received.

[Case 2] Example of Processing when Failure has Occurred in Master-Side Forwarding Device

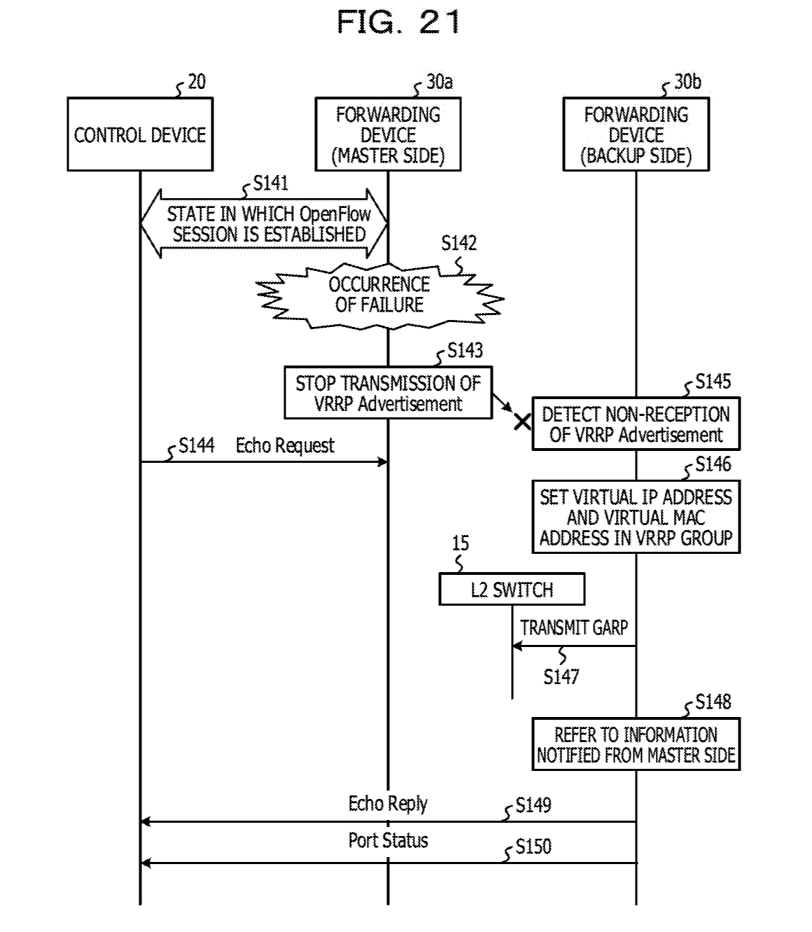

FIG. 21 is a sequence diagram for explaining an example of switching processing when a failure has occurred in a master-side forwarding device. The master-side forwarding device illustrated in FIG. 21 may be the master-side forwarding device 30a illustrated in FIG. 2. Also when the master-side forwarding device 30a breaks down, the switching processing of the forwarding device 30 is executed in the state in which the forwarding device 30a keeps the communication session with the control device 20. Details of the switching processing will be described below with reference to FIG. 21. FIG. 21 is one example of the processing. Change in the timing of processing, such as concurrent execution of processing of S149 and S150, may be made. Also in FIG. 21, the timing of a coupling such as a connection of a lower layer between the control device 20 and the backup-side forwarding device 30b is arbitrary timing before taking over the OpenFlow session.

At the timing of S141, a failure has not occurred in the forwarding device 30a. In S141, the forwarding device 30a is operating as the master-side forwarding device 30 and thus has established the OpenFlow session with the control device 20. The synchronization processing unit 53a periodically transmits VRRP Advertisement to the forwarding device 30b. Thus, the forwarding device 30b determines that communications through the forwarding device 30a are being carried out.

A failure occurs in the forwarding device 30a (S142). The detecting unit 45a in the forwarding device 30a stops the response to alive monitoring from the control device 20 due to the occurrence of the failure. Moreover, the synchronization processing unit 53a also stops synchronization processing with the backup-side forwarding device 30b and transmission of VRRP Advertisement to the backup-side forwarding device 30b (S143).

After the occurrence of the failure in the forwarding device 30a, an Echo Request message is transmitted from the control device 20 (S144). However, at the timing of S144, the response to the alive monitoring from the control device 20 has been stopped due to the occurrence of the failure and thus a response to the control device 20 is not made from the forwarding device 30a.

Meanwhile, because the transmission of VRRP Advertisement from the forwarding device 30a is stopped, the detecting unit 51b detects non-reception of VRRP Advertisement (S145). The detecting unit 51b in the forwarding device 30b determines that a failure has occurred in the master-side forwarding device 30a. Processing of S146 to S148 is similarly to the processing executed in S98 to S100 described with reference to FIG. 16. By using control information, the switching unit 52b transmits an Echo Reply message to the control device 20 through the communication session established between the control device 20 and the forwarding device 30a (S149). Because the Echo Reply message is transmitted to the control device 20 by using the already-established communication session, the control device 20 determines that the forwarding device 30 in communications is operating, and continues the communication control without notifying the already-transmitted processing rule and so forth again. Moreover, the switching unit 52b notifies the control device 20 of the status of ports in the forwarding device 30b by transmitting a Port Status message to the control device 20 (S150).

Here, regarding the case in which a failure has occurred in the master-side forwarding device 30, the time it takes to carry out the switching and the timing of alive monitoring will be described. As with the description with FIG. 16, the period from the time at which the detecting unit 51b determines that a failure has occurred in communications through the master-side forwarding device 30a to transmission of an Echo Reply message is defined as a first period. The period for which the control device 20 waits for Echo Reply in alive monitoring between the control device 20 and the forwarding device 30a is defined as a second period. As described above, the first period is set shorter than the second period. For this reason, although Echo Reply is not transmitted from the master-side forwarding device 30a to the control device 20, the OpenFlow session is kept if Echo Reply transmitted from the forwarding device 30b reaches the control device 20.

For example, Echo Request is transmitted at intervals of 10 seconds for the alive monitoring between the control device 20 and the master-side forwarding device 30. Timeout detection in the control device 20 (second period) is substantially 30 seconds after the transmission of Echo Request. Next, a consideration will be made about the first period. If the transmission interval of VRRP Advertisement is substantially one second, switching of the forwarding device 30 will occur at the elapse of substantially three seconds after the occurrence of a failure in the master-side forwarding device 30a. When the time it takes to carry out transmission and reception of the GARP between the forwarding device 30b and the L2 switch 15 and so forth after the backup-side forwarding device 30b is switched to the master side is also taken into consideration, the first period may be estimated to be substantially 10 seconds, for example. In this case, the second period is longer than the first period and thus the side of the control device 20 keeps the OpenFlow session without recognizing the switching of the forwarding device 30. These numerical values are one example and the interval of the alive monitoring between the devices may be changed according to the implementation. However, the first period is set shorter than the second period.

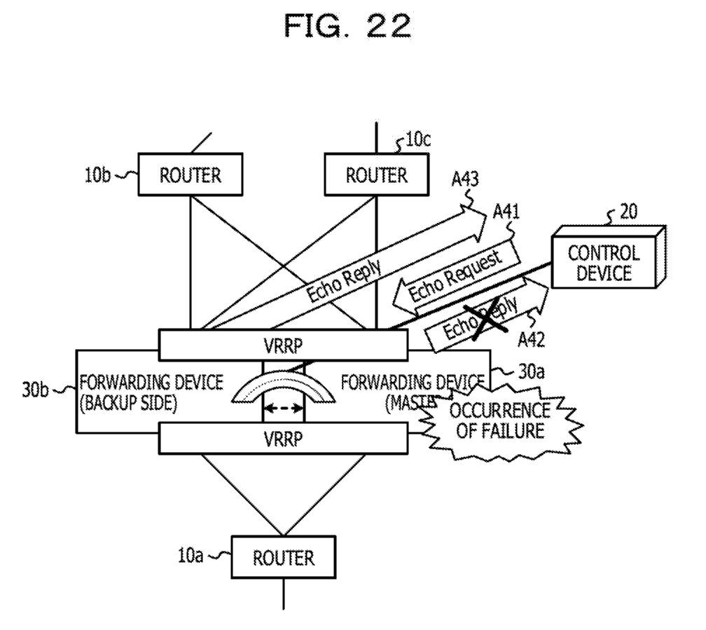

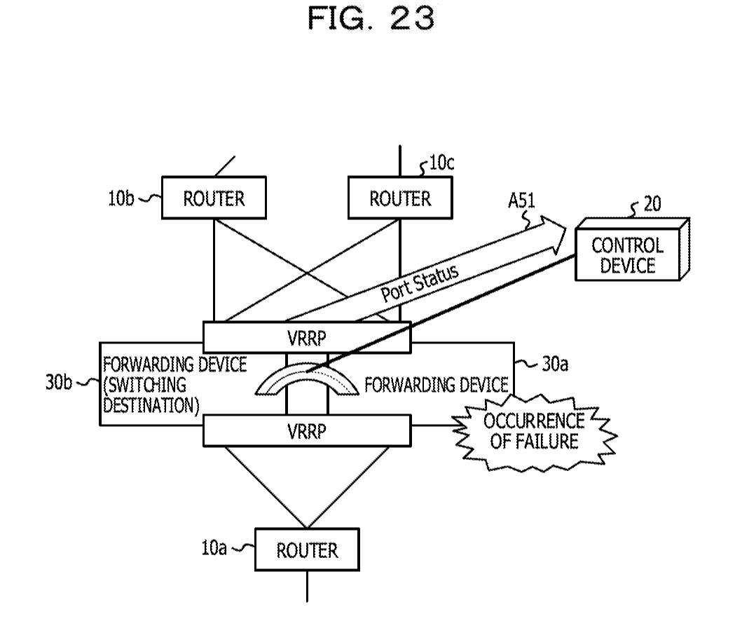

FIG. 22 is a diagram for explaining an example of communication processing with a control device when a failure has occurred in a master-side forwarding device. The control device and the master-side forwarding device illustrated in FIG. 22 may be the control device 20 and the master-side forwarding device 30a illustrated in FIG. 2. FIG. 22 represents an example of communications carried out between the VRRP group including the forwarding device 30b and the control device 20 in S142 to S149 in FIG. 21. Also in FIG. 22 and FIG. 23, each of the forwarding device 30a and the forwarding device 30b is coupled to the router 10a with the intermediary of the L2 switch 15. However, the L2 switch 15 is not represented in FIG. 22 and FIG. 23 for easy viewing of the diagrams.

When the forwarding device 30a breaks down, the forwarding device 30a stops communications with the control device 20 and the forwarding device 30b as described with reference to S143 in FIG. 21. In FIG. 22, the stop of transmission of control packets and update information between the forwarding device 30a and the forwarding device 30b is represented by a dashed arrow that links the forwarding device 30a and the forwarding device 30b.

As described with S144 in FIG. 21, an Echo Request message is transmitted from the control device 20 as represented by an arrow A41 after the forwarding device 30a breaks down. In this case, the detecting unit 45a in the forwarding device 30a does not generate an Echo Reply message even when the receiving unit 33a receives the Echo Request message. Thus, the Echo Reply message is not transmitted from the forwarding device 30a to the control device 20 (arrow A42). However, as described with reference to FIG. 21, after switching of the master-side device, the switching unit 52b of the forwarding device 30b transmits an Echo Reply message through the communication session used for communications between the control device 20 and the forwarding device 30a (arrow A43). The processing of the arrow A43 is equivalent to S149 in FIG. 21. Thus, the communication session between the forwarding device 30b that operates as the master side after the switching processing and the control device 20 is not a session newly established and the processing rule that has been notified from the control device 20 to the forwarding device 30a is not transmitted to the forwarding device 30b.

FIG. 23 is a diagram for explaining an example of transmission processing of port information. FIG. 23 represents the processing of S150 in FIG. 21. After the switching processing ends, the forwarding device 30b that has started operation as the master side due to the switching processing notifies the control device 20 of the status of ports of the forwarding device 30b (arrow A51). This processing allows the control device 20 to carry out forwarding control according to the status of ports in the forwarding device 30b after the switching.

As above, even when switching due to breakdown of the master-side forwarding device 30 occurs, the backup-side forwarding device 30b uses the communication session established by the master-side forwarding device 30a with the control device 20. Therefore, the control device 20 does not recognize the occurrence of the failure in the forwarding device 30a of the communication destination and the switching of the communication destination from the forwarding device 30a to the forwarding device 30b. This saves the control device 20 from retransmitting the processing rule that has been already transmitted to the forwarding device 30a to the forwarding device 30b after the switching processing, so that useless communications between the control device 20 and the forwarding device 30 are reduced. The forwarding device 30b acquires the processing rule transmitted before the switching through the forwarding device 30a. Thus, the forwarding processing unit 43b of the forwarding device 30b may execute processing of packets in accordance with the processing rule although the processing rule that has been already transmitted to the forwarding device 30a by the control device 20 is not newly received.

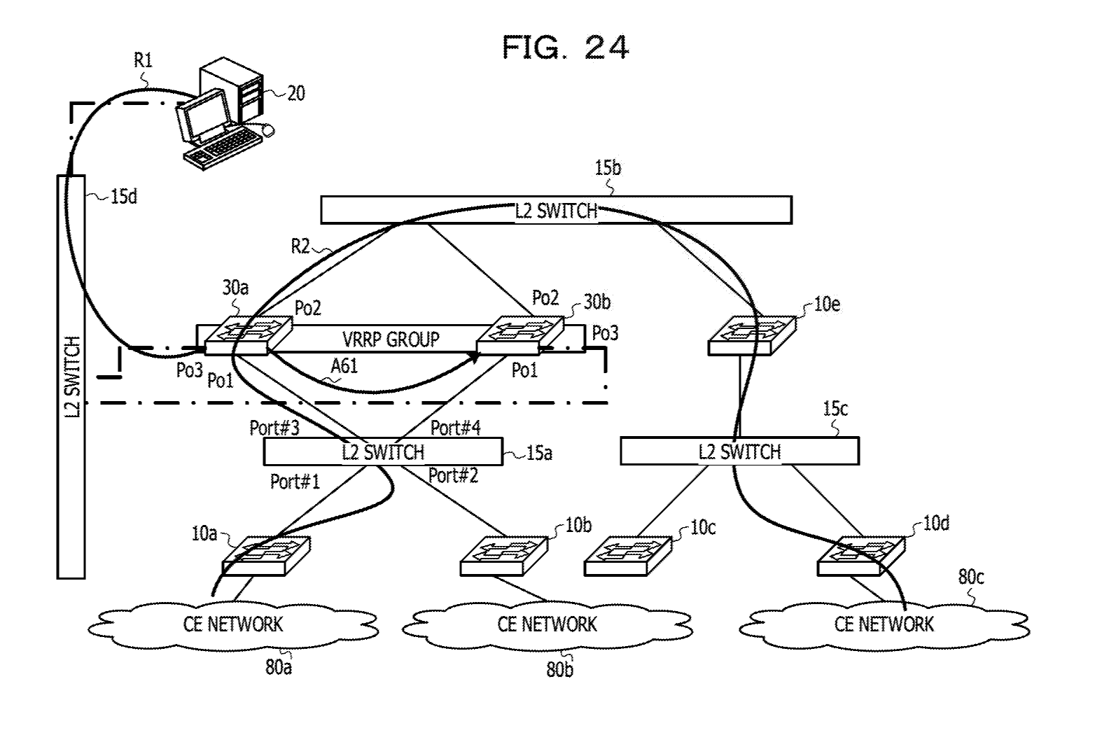

FIG. 24 is a diagram for explaining an example of a system to which a forwarding method according to the embodiment is applied. FIG. 24 is an example of the system, and the numbers of routers 10, forwarding devices 30, L2 switches 15, customer edge (CE) networks 80, and so forth in the system and the numbers of ports and interfaces the respective devices have are arbitrary.

An example of processing when the method according to the embodiment is applied in the system illustrated in FIG. 24 will be described below. The system of FIG. 24 includes the routers 10 (10a to 10e), the L2 switches 15 (15a to 15d), the control device 20, the forwarding device 30a, and the forwarding device 30b. The system includes the CE networks 80 (80a to 80c). One-dot-chain lines in FIG. 24 are control lines used for control processing between the control device 20 and the forwarding devices 30. Solid lines are lines used for transmission and reception of data. In FIG. 24, lines used for communications between the control device 20 and the routers 10 are not depicted in FIG. 24 for easy viewing of the diagram. However, if the routers 10 correspond to the OpenFlow, each router 10 is coupled to the control device 20 by a control line. In the following description, the routers 10 correspond to the OpenFlow. Therefore, the control device 20 may communicate with each of the routers 10a to 10e, the forwarding device 30a, and the forwarding device 30b through the L2 switch 15d.

The router 10a is coupled to the CE network 80a. The router 10b is coupled to the CE network 80b. The CE network 80c is coupled to the router 10d. Port #1, port #2, port #3, and port #4 of the L2 switch 15a are coupled to the router 10a, the router 10b, the forwarding device 30a, and the forwarding device 30b, respectively.

The forwarding device 30a and the forwarding device 30b are included in a VRRP group. Port Pot, port Pot, and port Po3 of the forwarding device 30a are coupled to the L2 switch 15a, the L2 switch 15b, and the L2 switch 15d, respectively. The forwarding device 30b is also coupled to the L2 switches 15a, 15b, and 15d similarly to the forwarding device 30a.

In the example of FIG. 24, the forwarding device 30a is operating as the master-side forwarding device 30 and the forwarding device 30b is operating as the backup-side forwarding device 30. The forwarding device 30a is normally operating and thus VRRP Advertisement is periodically transmitted from the forwarding device 30a to the forwarding device 30b as represented by an arrow A61. Moreover, a communication session has been established between the control device 20 and the master-side forwarding device 30a. Furthermore, processing rules and control messages are transmitted and received through the established communication session. Communications by the communication session established between the control device 20 and the forwarding device 30a are carried out on a route represented as a route R1.

The routers 10 and the forwarding device 30a in the network are notified of a processing rule of packets from the control device 20 and therefore the system is in the state in which transmission and reception of packets between the CE networks 80 is possible. For example, when a device in the CE network 80a transmits packets to a device in the CE network 80c, a communication route represented as a route R2 is used.

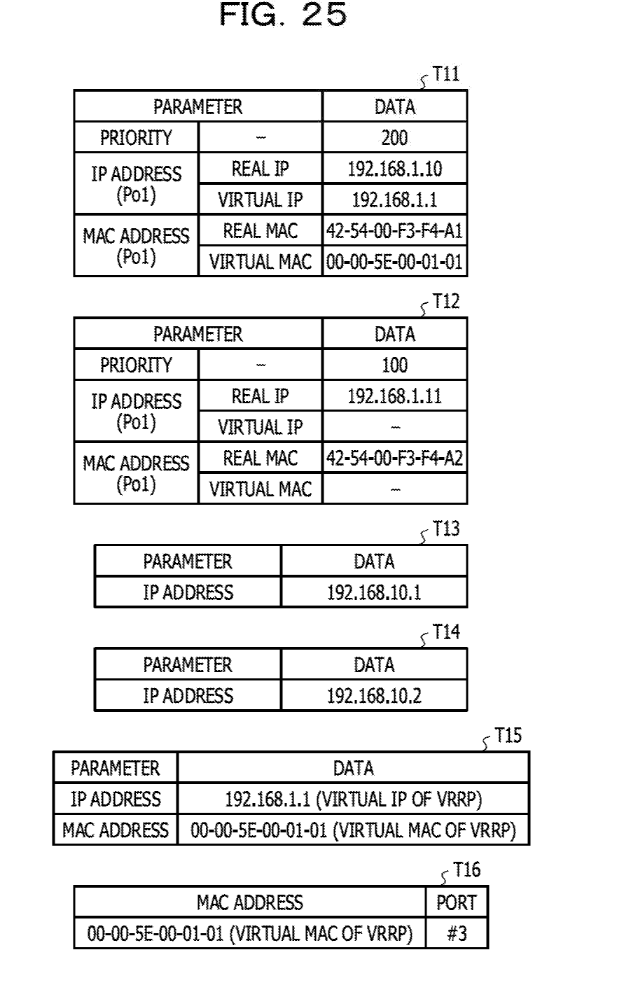

FIG. 25 is a diagram for explaining an example of pieces of information held by respective devices. In the system of FIG. 24, the forwarding device 30a holds information represented in a table T11. The forwarding device 30b holds information represented in a table T12. Meanwhile, the IP address of the router 10a is set to 192.168.10.1. Thus, the router 10a holds a table T13 as setting information of the corresponding IP address. The IP address of the router 10b is set to 192.168.10.2. Thus, the router 10b holds a table T14 as setting information of the IP address. Moreover, the L2 switch 15a holds information of a table T15 as an ARP table. The L2 switch 15a holds information of a table T16 as a MAC address table.

If the respective pieces of information represented in FIG. 25 are used, the forwarding device 30a operates as the master-side forwarding device 30 because the priority set in the forwarding device 30a is 200 whereas the priority of the forwarding device 30b is 100. Moreover, the IP address assigned to the interface including port Pot of the forwarding device 30a is 192.168.1.10 and the MAC address is 42-54-00-F3-F4-A1. On the other hand, the IP address assigned to the interface including port Pot of the forwarding device 30b is 192.168.1.11 and the MAC address is 42-54-00-F3-F4-A2. In communications of the VRRP group formed by the forwarding device 30a and the forwarding device 30b, the virtual IP address used for processing of packets received from the L2 switch 15a is 192.168.1.1 and the virtual MAC address is 00-00-5E-00-01-01. In the status described with reference to FIG. 24 and FIG. 25, the forwarding device 30a operates as the master side and thus the forwarding device 30a receives packets in which the virtual IP address or the virtual MAC address used for the communications of the VRRP group is set as the destination. For this reason, as the addresses of the processing target, virtual IP address=192.168.1.1 and virtual MAC address=00-00-5E-00-01-01 are set in the table T11.

In the table T15, virtual IP address=192.168.1.1 and virtual MAC address=00-00-5E-00-01-01 are associated. Moreover, in the table T16, virtual MAC address=00-00-5E-00-01-01 is associated with port #3. Thus, packets addressed to the virtual MAC address used in the combination of ports Pot of the forwarding device 30a and the forwarding device 30b are output from port E3 of the L2 switch 15a. For this reason, packets in which virtual MAC address=00-00-5E-00-01-01 is set as destination MAC address are output from the L2 switch 15a to the forwarding device 30a.

For example, if a packet to be transmitted from a device in the CE network 80a to a device in the CE network 80c is forwarded along the route R2, the packet is forwarded from the router 10a toward the CE network 80c. At this time, by using a routing table, the router 10a sets the MAC address of the forwarding destination to the virtual MAC address used in the combination of ports Pot of the forwarding device 30a and the forwarding device 30b. Therefore, the destination MAC address of the packet of the forwarding target is set to MAC address=00-00-5E-00-01-01. Accordingly, based on the table T16, the packet addressed to the device in the CE network 80c is output from the L2 switch 15a toward the forwarding device 30a.

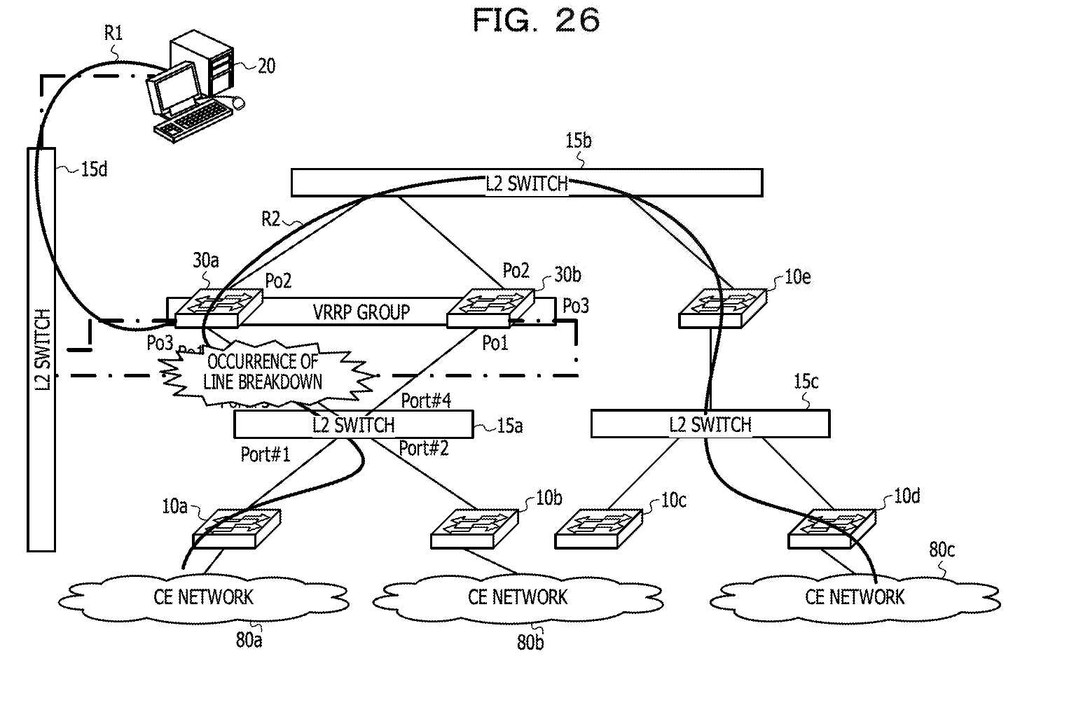

FIG. 26 is a diagram for explaining an example of a case in which a failure in a line is detected in a master-side forwarding device. The master-side forwarding device illustrated in FIG. 26 may be the master-side forwarding device 30a illustrated in FIG. 24. The detecting unit 45a in the forwarding device 30a fails in a communication check with the router 10a. Thereupon, the detecting unit 45a determines that a failure has occurred in the line between the forwarding device 30a and the router 10a. The synchronization processing unit 53a stops transmission of VRRP Advertisement to the forwarding device 30b.

If VRRP Advertisement has not been received for a given period or longer, the detecting unit 51b in the forwarding device 30b determines that a failure in a communication route through the forwarding device 30a or the forwarding device 30a has occurred. The detecting unit 51b requests the switching unit 52b to start communications with the control device 20.

The switching unit 52b sets the virtual IP address and the virtual MAC address assigned to the VRRP group as addresses for processing in the forwarding device 30b in order for the forwarding device 30b to operate as the master-side forwarding device 30. This setting is carried out regarding each interface the forwarding device 30b has. Moreover, the switching unit 52b transmits the GARP to the L2 switch 15a. At this time, the switching unit 52b transmits the GARP with use of virtual IP address=192.168.1.1 and virtual MAC address=00-00-5E-00-01-01 for processing through the interface including port P1.

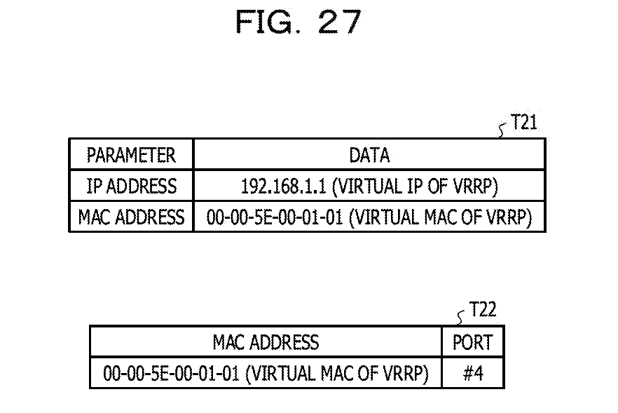

FIG. 27 is a diagram for explaining an example of information held by an L2 switch. The L2 switch illustrated by reference to FIG. 27 may be the L2 switch 15a illustrated in FIG. 24. The L2 switch 15a receives the GARP including virtual IP address=192.168.1.1 and virtual MAC address=00-00-5E-00-01-01 from Port #4. Thus, the L2 switch 15a associates MAC address=00-00-5E-00-01-01 with port #4 as represented in the MAC address table of a table T22 in FIG. 27. Although the L2 switch 15a receives the GARP through port #4, the combination of the IP address and the MAC address notified by the GARP is registered in the ARP table. For this reason, the information in the ARP table is not changed from the state before switching of the master-side forwarding device 30 (table T15 in FIG. 25) as represented in a table T21 in FIG. 27.

Thereafter, the switching unit 52b transmits packets of an Echo Reply message, a Port Status message, and so forth to the control device 20 by using the communication session used for communications between the forwarding device 30a and the control device 20.

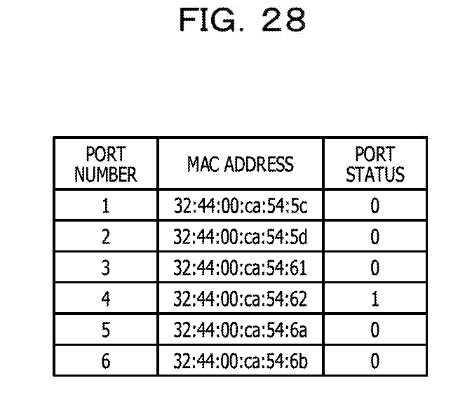

FIG. 28 is a diagram for explaining an example of a port information table. The port information table illustrated in FIG. 28 may be the port information table illustrated in FIG. 3. The switching unit 52b refers to the port information table 62b for generating the Port Status message. In the example illustrated in FIG. 28, in the port information table 62, a port number, a MAC address, and a port status are associated. The MAC address is the MAC address assigned to the port identified by the port number in the entry. The port status represents the status of the port identified by the port number in the entry. In the example of FIG. 28, a failure has occurred in the port with port number=4. However, a failure has not occurred in the ports with port number=1 to 3, 5, 6. Coupling by use of the ports with port number=4 to 6 in the forwarding device 30b is not diagrammatically represented. However, the ports with port number=4 to 6 may be either used or unused.

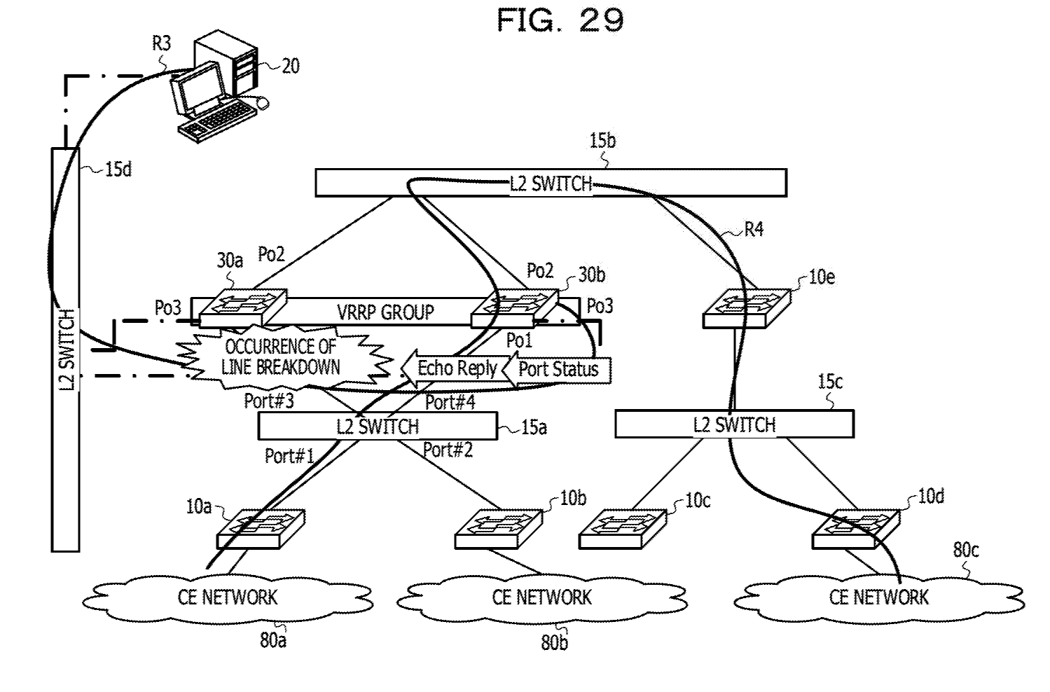

FIG. 29 is a diagram for explaining an example of a state when switching processing has been completed. Communications between the forwarding device 30b and the control device 20 are carried out by using the communication session used for communications between the forwarding device 30a and the control device 20. However, the communication route is the route that links port Po3 of the forwarding device 30b and the control device 20. Thus, the communications are carried out by using the route represented as a route R3 in FIG. 29. Packets of the Echo Reply message and so forth are also transmitted to the control device 20 by using the route of the communication session used after the completion of the switching processing. Therefore, the state in which these packets are transmitted is also diagrammatically represented in FIG. 29.

A route R4 is an example of a communication route used when a device in the CE network 80a communicates with a device in the CE network 80c after the switching processing from the forwarding device 30a to the forwarding device 30b. As represented in the table T22 in FIG. 27, virtual MAC address=00-00-5E-00-01-01 is associated with port #4. Thus, packets addressed to virtual MAC address=00-00-5E-00-01-01 are output from port #4 of the L2 switch 15a. Forwarding processing of packets in the router 10a is not changed due to switching of the forwarding device 30. For this reason, the destination MAC address of packets transmitted to the device in the CE network 80c is set to 00-00-5E-00-01-01. Therefore, based on the table T22, the packets addressed to the device in the CE network 80c are output from the L2 switch 15a to the forwarding device 30b.

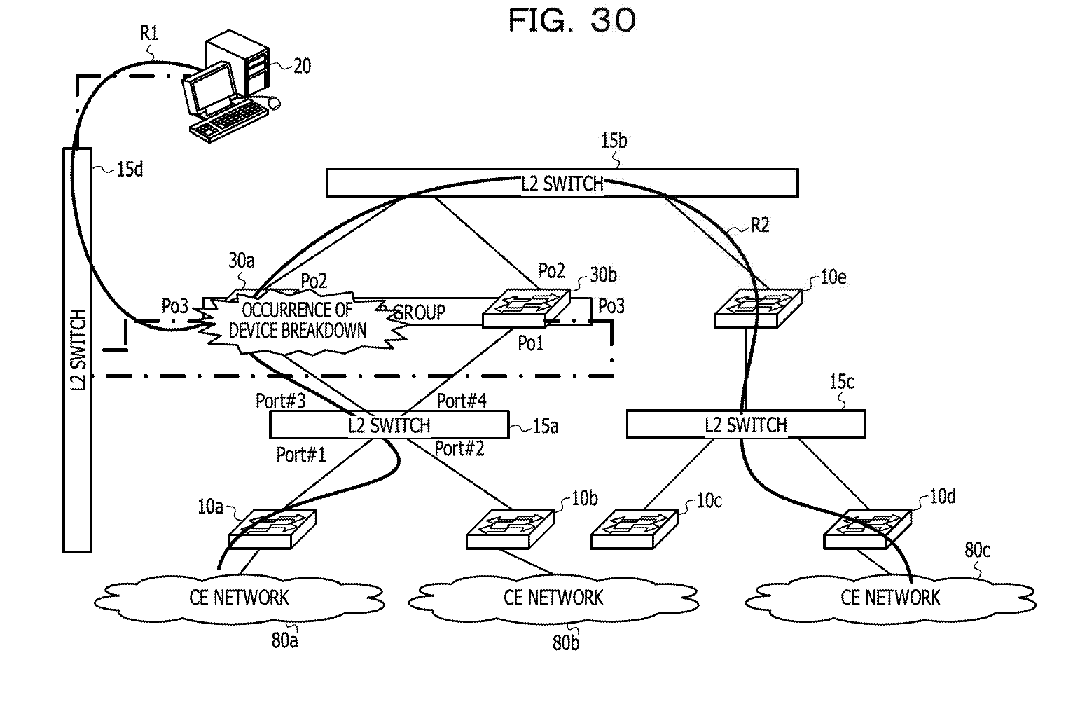

FIG. 30 is a diagram for explaining an example of a case in which a failure occurs in a master-side forwarding device. The master-side forwarding device illustrated in FIG. 30 may be the master-side forwarding device 30a illustrated in FIG. 24. When a failure occurs in the forwarding device 30a, the synchronization processing unit 53a stops transmission of VRRP Advertisement to the forwarding device 30b.

If VRRP Advertisement has not been received for a given period or longer, the detecting unit 51b in the forwarding device 30b determines that a failure in a communication route through the forwarding device 30a or the forwarding device 30a has occurred. Thereupon, by the processing like the processing described with reference to FIG. 26 to FIG. 29, the forwarding device 30 that operates as the master side is switched from the forwarding device 30a to the forwarding device 30b.

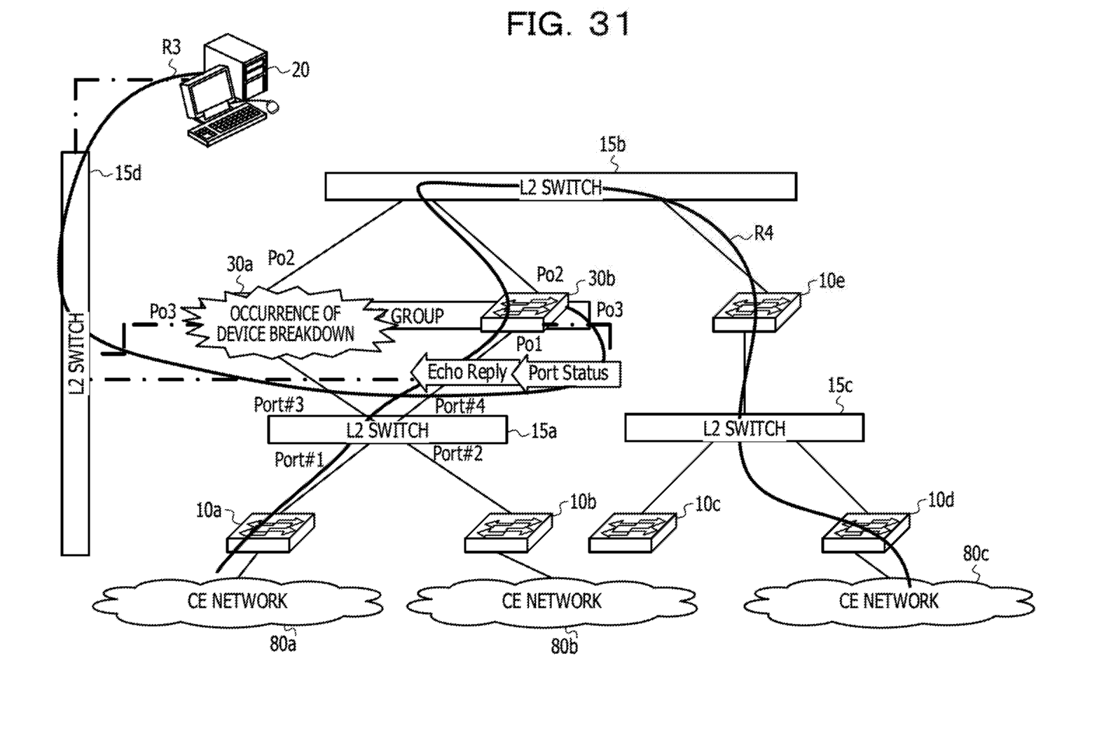

FIG. 31 is a diagram for explaining an example of a state when switching processing has been completed. Communications between the forwarding device 30b and the control device 20 are carried out by using the communication session used for communications between the forwarding device 30a and the control device 20. However, the communication route is the route that links port Po3 of the forwarding device 30b and the control device 20. Thus, the communications between the control device 20 and the forwarding device 30b are carried out by using the route represented as the route R3 in FIG. 31. Packets of the Echo Reply message and so forth are also transmitted to the control device 20 by using the route R3 of the communication session used after the completion of the switching processing. Therefore, the state in which these packets are transmitted is also diagrammatically represented in FIG. 31.

The route R4 represents a route through which packets transmitted from a device in the CE network 80a to a device in the CE network 80c are forwarded after the forwarding device 30 that operates as the master side is switched from the forwarding device 30a to the forwarding device 30b. The route R4 is obtained by the processing described with reference to FIG. 29.

As described above, even when switching due to breakdown of the master-side forwarding device 30 or the occurrence of a failure in a line occurs, the backup-side forwarding device 30b uses the communication session established by the master-side forwarding device 30a with the control device 20. Therefore, the control device 20 does not recognize the switching of the control target in the VRRP group from the forwarding device 30a to the forwarding device 30b. This saves the control device 20 from retransmitting the processing rule that has been already transmitted to the forwarding device 30a to the forwarding device 30b after the switching processing, so that useless communications between the control device 20 and the forwarding device 30 are reduced.

The embodiment is not limited to the above description and may be variously modified. Several examples of the modification will be described below.

The detecting unit 51 in the backup-side forwarding device 30 may obtain the time interval of reception of a packet from the master-side forwarding device 30 and compare the time interval with a threshold. Here, the packet received from the master side may be VRRP Advertisement or may be a packet used for notification of a processing rule, such as FlowMod. Moreover, the threshold compared with the time interval of reception of the packet, for example, may be set to a given multiple of the period for which the backup-side forwarding device 30 waits for reception of VRRP Advertisement or the like. If a packet has not been received from the master side for the given period represented by the threshold or longer, the detecting unit 51 may determine that a failure in the master-side forwarding device 30 has occurred or a failure in a line coupled to the master-side forwarding device 30 has occurred. Thus, if a packet has not been received from the master side for the given period or longer, the coupling processing unit 54 starts communications with the control device 20 by using the communication session used for communications with the control device 20 by the master-side forwarding device 30.

With reference to FIG. 13, an example of the case in which the backup-side forwarding device 30 stores update information when updating the flow table 64 or the group table 65 is described. However, the backup-side forwarding device 30 does not have to store update information. If the configuration is modified in this manner, the table information processing unit 42 acquires, from the switching unit 52 or the like, information indicating which of the backup side and the master side the self-device is operating as. If the self-device is operating as the backup side, the table information processing unit 42 does not temporarily store update information. Therefore, S65, S67, and S69 in FIG. 13 may be omitted.

The information elements in the messages and the information elements in the tables used in the above description are one example. The information elements in the messages and the information elements in the tables may be arbitrarily changed according to the implementation.

In the above description, the case in which the VRRP is used for providing redundancy of the forwarding device 30 is taken as an example. However, providing redundancy of the forwarding device 30 may be carried out by another protocol. The protocol used for control of the network is also not limited to the OpenFlow. Moreover, the kinds of control information used for alive monitoring and detection of a failure may also be changed. For example, if the time it takes to carry out switching of the forwarding device 30 is shorter than the time it takes to carry out timeout detection in alive monitoring between the control device 20 and the master-side forwarding device 30, the protocol used, the kind of control packet, and so forth may be changed according to the implementation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A forwarding method executed by a processor included in a first forwarding device in a network in which redundancy is provided by using the first forwarding device and a second forwarding device that operate based on a processing rule of a packet set in a control device, the forwarding method comprising:
acquiring, from the second forwarding device, a processing rule received by the second forwarding device from the control device and control information used to maintain a communication session between the second forwarding device and the control device; and
starting communication with the control device through the communication session by using the control information when a given packet for alive monitoring has not been received from the second forwarding device for a given period or longer.

2. The forwarding method according to claim 1,
wherein a first period that is a period from detecting that the given packet for alive monitoring has not been received from the second forwarding device for the given period or longer to the starting communication with the control device through the communication session by the first forwarding device is shorter than a second period that is a period for which the control device waits for a reply packet to a packet transmitted by the control device in order to determine whether the control device is allowed to communicate with the second forwarding device.

3. The forwarding method according to claim 1, further comprising:
transmitting a notification packet to notify the second forwarding device of that the first forwarding device is operating when a communication failure in a line coupled to the first forwarding device is not detected while the communication session is maintained with the control device; and
stopping transmission of the notification packet to the second forwarding device when a failure in the line is detected.

4. The forwarding method according to claim 3, further comprising
when the first forwarding device receives a determination packet used for determination of whether communication through the first forwarding device is possible from the control device after the failure in the line is detected, transmitting a response packet to the determination packet to the control device.

5. The forwarding method according to claim 1,
wherein the starting includes starting communication with the control device before timeout of the communication session by using a virtual address assigned to a group including the first forwarding device and the second forwarding device and the control information.

6. The forwarding method according to claim 1, further comprising:
receiving a packet;
processing the received packet by using the processing rule stored by the first forwarding device when the processing rule is allowed to be applied to the received packet; and
acquiring a new processing rule from the control device by communicating with the control device by use of the communication session taken over from the second forwarding device when the processing rule stored by the first forwarding device is not allowed to be applied to the received packet.

7. The forwarding method according to claim 1,
wherein the first forwarding device and the second forwarding device store flow information in which, regarding each of a plurality of characteristics of a packet, the characteristic of the packet and a processing method of the packet are associated, and
wherein the method further comprising:
receiving difference between the flow information before update and the flow information after update from the second forwarding device when the flow information of the second forwarding device is updated; and
updating the flow information of the first forwarding device based on the difference.

8. A forwarding device that operates as a first forwarding device in a network in which redundancy is provided by using the first forwarding device and a second forwarding device that operate based on a processing rule of a packet set in a control device, the forwarding device comprising:
a memory; and
a processor coupled to the memory and configured to:
acquire, from the second forwarding device, a processing rule received by the second forwarding device from the control device and control information used to maintain a communication session between the second forwarding device and the control device, and
start communication with the control device through the communication session by using the control information when a given packet for alive monitoring has not been received from the second forwarding device for a given period or longer.

9. The forwarding device according to claim 8,
wherein a first period that is a period from detecting that the given packet for alive monitoring has not been received from the second forwarding device for the given period or longer to the starting communication with the control device through the communication session by the first forwarding device is shorter than a second period that is a period for which the control device waits for a reply packet to a packet transmitted by the control device in order to determine whether the control device is allowed to communicate with the second forwarding device.

10. The forwarding device according to claim 8, wherein the processor is configured to:
transmit a notification packet to notify the second forwarding device of that the first forwarding device is operating when a communication failure in a line coupled to the first forwarding device is not detected while the communication session is maintained with the control device; and
stop transmission of the notification packet to the second forwarding device when a failure in the line is detected.

11. The forwarding device according to claim 10, wherein the processor is configured to
when the first forwarding device receives a determination packet used for determination of whether communication through the first forwarding device is possible from the control device after the failure in the line is detected, transmit a response packet to the determination packet to the control device.

12. The forwarding device according to claim 8,
wherein the processor is configured to start communication with the control device before timeout of the communication session by using a virtual address assigned to a group including the first forwarding device and the second forwarding device and the control information.
